(19) United States
(12) Patent Application Publication
(10) Pub. No.: US 2014/0039935 A1
(43) Pub. Date: Feb. 6, 2014

(54) INSURANCE VERIFICATION SYSTEM (INSVSYS)

(71) Applicant: SEGA DATA LOGISTICS, INC., Miami, FL (US)

(72) Inventor: Gabriel Ernesto RIVERA, Miami, FL (US)

(73) Assignee: Sega Data Logistics, Inc., Miami, FL (US)

(21) Appl. No.: 13/833,652

(22) Filed: Mar. 15, 2013

Related U.S. Application Data
(63) Continuation-in-part of application No. 13/564,144, filed on Aug. 1, 2012.

(51) Int. Cl. G06Q 40/08

(52) U.S. Cl. CPC G06Q 40/08
USPC 705/4

(57) ABSTRACT

A method and system for uniquely identifying an entity is disclosed. The method includes receiving information corresponding to the entity, the information corresponding to the entity including insurance data. A unique identifier of a plurality of unique identifiers is assigned to the entity. The unique identifier is associated to the information corresponding to the entity. The unique identifier is stored in association with the information corresponding to the entity for future retrieval by the entity. A confirmation of the assignment of the unique identifier is sent to the entity. A determination is made that the unique identifier is unavailable for assignment to another entity different from the entity.

### CROSS-REFERENCE TO RELATED APPLICATION

n/a

### STATEMENT REGARDING FEDERALLY SPONSORED RESEARCH OR DEVELOPMENT

n/a

### TECHNICAL FIELD

The present invention relates to a method and system for verifying insurance information.

### BACKGROUND

The accurate storage, retrieval and providing of personal information has become an important aspect of modern life. A person continuously provides personal information, such as a telephone number, home address, age, driver license, etc., to many different requesters. The requesters may be employers, government authorities, retailers, financial institutions, insurance companies, etc. It is cumbersome to provide the same personal information over and over again to different requesters. For example, a person who wants to purchase an insurance policy may wish to provide the same insurance information, e.g., policy limits, insurance deductible, insurance coverage, etc., to different insurance carriers in order to compare rates.

Additionally, it is inefficient both for (i) the provider of the information to procure the same information again and again to each different requester, and (ii) for each requester to spend time and resources collecting and storing the same information. Many times the person may send the personal information electronically to each requester. However, each requester may request a different set of insurance information, which may require a person to customize the insurance information for every requester. Further, repeatedly providing the same information to different requesters may also increase the chance that one of the requesters receiving the information may enter the information incorrectly in their systems.

It is desirable to have a method and system that allows insurance information to be conveniently stored and provided to third parties.

### SUMMARY

The present invention advantageously provides a method and system for uniquely identifying an entity is disclosed. The method includes receiving information corresponding to the entity, the information corresponding to the entity including insurance data. A unique identifier of a plurality of unique identifiers is assigned to the entity. The unique identifier is associated to the information corresponding to the entity. The unique identifier is stored in association with the information corresponding to the entity for future retrieval by the entity. A confirmation of the assignment of the unique identifier is sent to the entity. A determination is made that the unique identifier is unavailable for assignment to another entity different from the entity.

In accordance with another aspect, an insurance verification computer for uniquely identifying an entity is provided. The insurance verification computer includes a transmitter, a memory, a receiver and a processor in communication with each other. The receiver is configured to receive information corresponding to the entity, the information corresponding to the entity including insurance data. The processor is configured to assign a unique identifier of a plurality of unique identifiers to the entity; and associate the unique identifier to the information corresponding to the entity. The memory is configured to store the unique identifier in association with the information corresponding to the entity for future retrieval by the entity. The transmitter is configured to transmit a confirmation of the assignment of the unique identifier to the entity. The processor is further configured to determine that the unique identifier is unavailable for assignment to another entity different from the entity.

In accordance with yet another aspect, a system for uniquely identifying an entity is provided. The system includes an insurance verification computer in communication with a government computer. The insurance verification computer includes a transmitter; a memory in communication with the transmitter; a receiver, the receiver in communication with the transmitter and the memory. The receiver is configured to receive information corresponding to the entity, the information corresponding to the entity including insurance data. The insurance verification computer also includes a processor in communication with the receiver, the transmitter and the memory. The processor configured to assign a unique identifier of a plurality of unique identifiers to the entity; and associate the unique identifier to the information corresponding to the entity. The memory is configured to store the unique identifier in association with the information corresponding to the entity for future retrieval by the entity. The transmitter is configured to transmit a confirmation of the assignment of the unique identifier to the entity. The processor is further configured to determine that the unique identifier is unavailable for assignment to another entity different from the entity. The government computer is at a port of entry. The government computer is in communication with the insurance verification computer. The government computer includes a government transmitter configured to transmit to the insurance verification computer a Vehicle Identification Number (“VIN”) associated with a motor vehicle and the unique identifier. The processor is further configured to determine, based at least on the VIN, whether the motor vehicle has been classified as stolen. If the processor determines that the motor vehicle has been classified as stolen, then the transmitter is further configured to send a warning message that the motor vehicle has been classified as stolen to the government computer.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary insurance verification system, in accordance with the principles of the present invention;

FIG. 2 is a block diagram of an exemplary insurance information repository storing insurance information, in accordance with the principles of the present invention;

FIG. 3 is a block diagram of an exemplary insurance verification computer, in accordance with the principles of the present invention;

FIG. 4 is a flow chart of an exemplary process for verifying insurance information, in accordance with the principles of the present invention; and

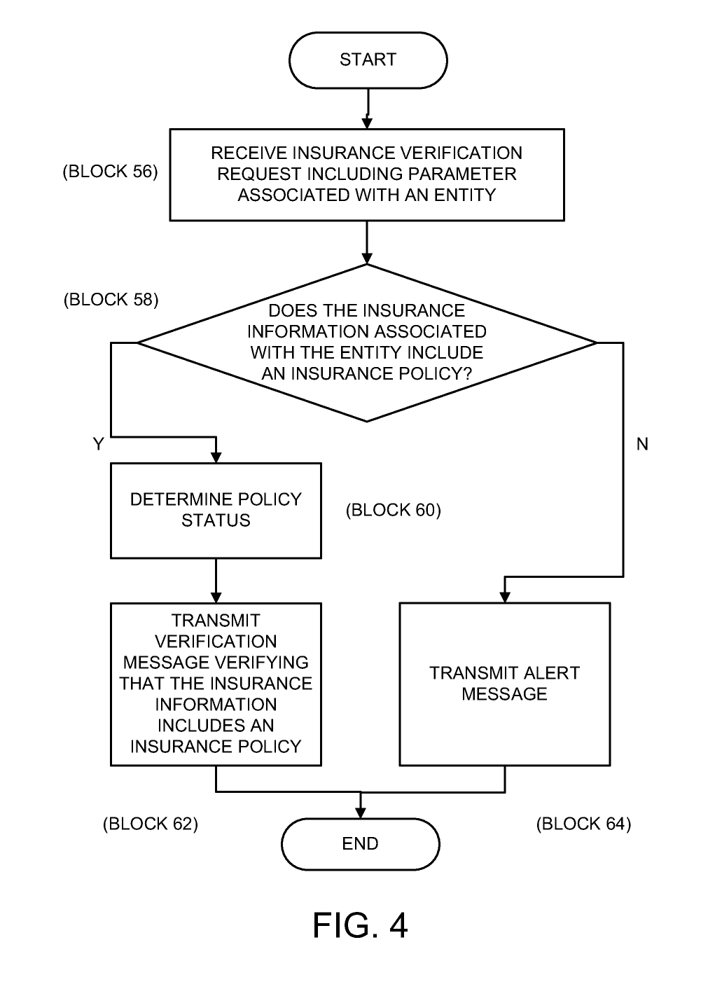

FIG. 5 is a flow chart of an exemplary process for uniquely identifying an entity.

### DETAILED DESCRIPTION

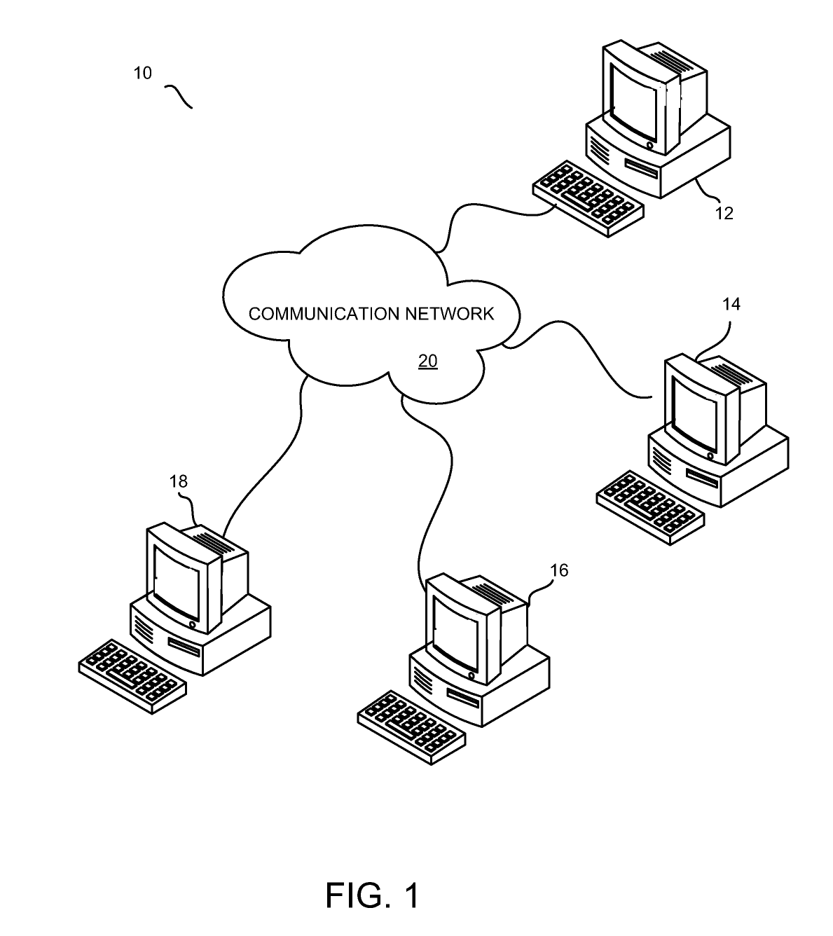

Referring now to the drawing figures in which reference designators refer to like elements, there is shown in FIG. 1 a schematic illustration of an insurance verification system in accordance with the principles of the present invention, and generally designated as “10”. Insurance verification system 10 includes insurance verification computer 12 configured to determine insurance information and transmit the determined insurance information to a third party computer. Insurance verification computer 12 may be in communication with one or more third party computers, such as government computer 14, insurance carrier computer 16 and financial institution computer 18 via communication network 20. Insurance verification computer 12 may store insurance information in insurance information repository/database 22.

Insurance verification computer 12 may be a computer server, a mainframe computer, a remote server, among other types of computing devices. Insurance verification computer 12 may receive an insurance information request message from a requester. The requester may wish to receive insurance information from insurance verification computer 12. The requester may be a third party computer, such as government computer 14, insurance carrier computer 16 and/or financial institution computer 18. The insurance information request message, i.e., the request for insurance information, may include a parameter associated with an entity. An entity may be, for example, a person or a company. The parameter associated with the entity may be a federal identification number, a name associated with an entity, a driver's license number corresponding to an entity, a tax identification number corresponding to an entity, among other identifications uniquely identifying an entity.

The insurance information verification request may include a request to verify whether the entity has insurance, i.e., whether the entity associated with the transmitted identification parameter has an active insurance policy. Insurance verification computer 12 may determine the requested insurance information, i.e., whether the entity is associated with an insurance policy, by querying insurance information repository 22. Insurance verification computer may transmit the requested insurance information to the requester via communication network 20.

Communication network 20 may include a cellular communication network and the Public Switched Telephone Network (“PSTN”), or other wide area network (“WAN”), such as the Internet, as well as local area networks (“LANs”), such as an Ethernet LAN. Communication network 20 may be an optical network, a wireless network, such as Wi-Fi, satellite, infrared, Bluetooth, Near Field Communications, or other communications network. Insurance verification computer 12, government computer 14, insurance carrier computer 16 and financial institution computer 18 may be connected via communication network 20 to other computers, such as an entity's computer and other computers associated with any other third party (not shown).

Government computer 14 may be a computer that stores government data including driving records. For example, government computer 14 may be a computer associated with a Department of Motor Vehicles. Government computer 14 may alternatively be a computer that stores police and criminal records, such as a law enforcement computer associated with a police department, the Department of Homeland Security or the Federal Bureau of Investigations. Government computer 14 may further be a computer that stores tax records, such as a computer associated with a Tax Collectors Office or the Internal Revenue Service. Insurance carrier computer 16 may be a computer associated with an insurance company, and financial institution computer 18 may be a computer associated with a financial institution, such as a bank, a credit card company, a credit report agency, a loan agency, etc.

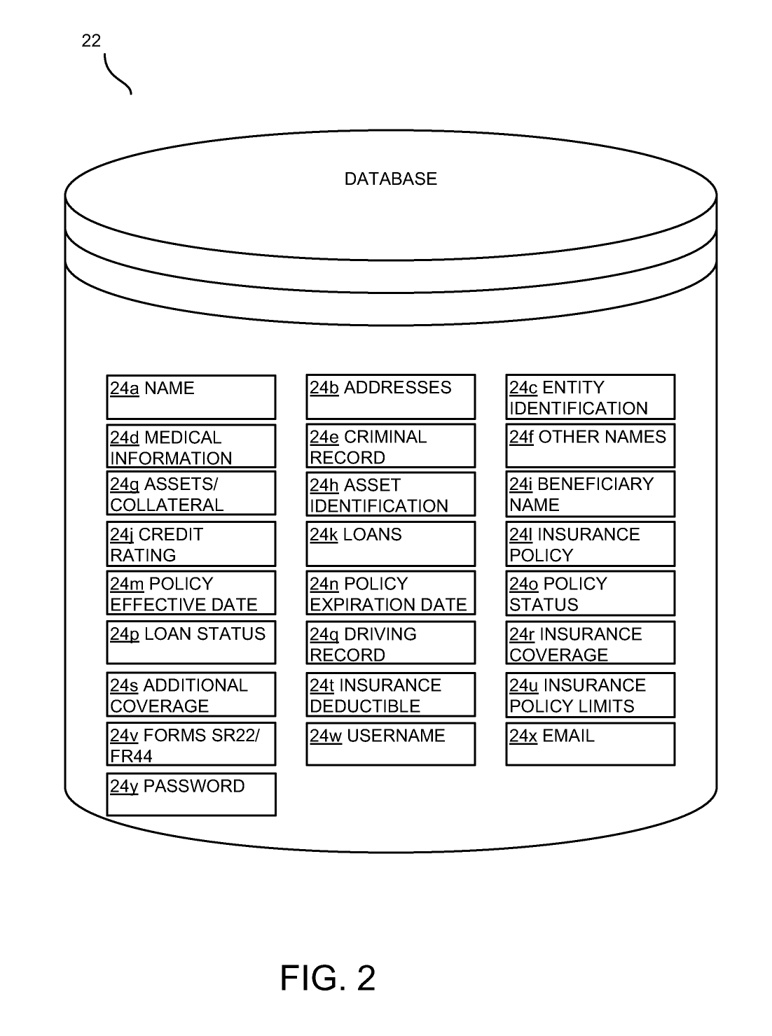

FIG. 2 is a block diagram of an exemplary insurance information repository 22. Insurance information repository 22 may be stored in a memory location of insurance verification computer 12. Insurance verification computer 12 may store insurance information associated with an entity as a comprehensive collection of related data organized for convenient access. Insurance verification computer 12 may store the insurance information in insurance information repository 22, which may be a database. Alternatively, insurance verification computer 12 may store the insurance information in any other format for organizing and relating data.

In an exemplary embodiment, insurance information repository 22 may be stored in another computer or a storage device in communication with insurance verification computer 12. Insurance information may include any information pertaining to an insurance policy. Insurance information repository 22 may associate the insurance information corresponding to an entity, with an identification, such as an entity identification number (e.g., a social security number). A search of insurance information repository 22 using a parameter that includes the entity identification will return insurance information corresponding to the entity.

Insurance information repository 22 stores insurance information associated with an entity. The insurance information may include, but may not be limited to any insurance policy information associated with an insurance policy purchased by an entity, loan information corresponding to loans associated with an entity, and documents. Documents may include a car insurance policy, a homeowners insurance policy, a motorcycle policy, a life insurance policy, a vehicle title, loan documentation, traffic tickets received by a person, supporting documentation for an insurance policy, bank account documentation, bank statements, receipts proving an amount paid for an insured asset, insurance claims, tax forms, etc.

The insurance information may further include an entity's name 24a, age, sex, date of birth, a list of addresses 24b associated with an entity (including a primary residence address and a business address), email address, and an entity identification 24c, such as a social security number, a government identification, a birth certificate information, a driver's license, passport number, etc. Insurance information may further include work related information such as an employer name, job title, salary, length of time working at employer, names of previous employers, etc. Insurance information may further include medical information 24d, information on previous existing health conditions, a medical history, health related information, such as blood type and medicines that a person is taking, health allergies, operations, hospitalizations, etc. Other insurance information may include a criminal record 24e, citizenship information, previous/other names used 24f, level of education, sources of income, military service information, tax information, number of dependants, monthly mortgage or rental payment, corporations associated with an entity, bank accounts, motor vehicles, e.g., automobiles own or leased by an entity, etc.

Insurance information may further include, but may not be limited to a list of assets that may be used as loan collateral 24g (such as automobiles, boats, recreational vehicles, jewelry, real estate, etc.); an asset identification 24h, such as a vehicle identification number (“VIN”); a description of an insured asset; a value of an asset; a list of liabilities; a monetary value associated with each liability; a list of properties owned by an entity; a value of each property; a name of a co-owner of a property; a name of a co-borrower; a name of a beneficiary 24i of an insurance policy; financial information associated with an entity, such as a credit rating 24j associated with an entity; and a list of loans 24k corresponding to an entity, such as an automobile loan, home loan, business loan, etc., among other insurance information.

Insurance information can further include information relevant to a contract, such as a loan contract or an insurance policy contract, including but not limited to at least one insurance policy 24l (active and inactive) associated with an entity; the policy effective date 24m; an expiration date, such as policy expiration date 24n; contract term, such as insurance policy term or loan term; loan payment history; insurance premium payment history; policy status 24o, such as whether the insurance policy is active and the premiums are being paid on-time or whether the insurance policy has lapsed and is inactive; and status of a loan 24p (whether it is being paid on-time or whether the loan is in default).

Insurance information may further include government information associated with an entity, such as a driving record 24q, which may be provided by an entity or the government. Driving record 24q may include the driving history, accidents, traffic violations, tickets, traffic related convictions corresponding to an entity, government forms 24v associated with an insurance policy, such as, an SR22 form which an insurance company provides to a government branch, such as a court or a Department of Motor Vehicles, to demonstrate proof of financial responsibility for persons convicted of a traffic violation. Another form stored in insurance information repository 22 may be an FR44 form used to demonstrate proof of financial responsibility for a person who was convicted of driving under the influence. The SR22 form and the FR44 form verify that a person has purchased insurance.

Other insurance information may include, but not be limited to, insurance policy history, such as a prior insurance policy and a type of insurance policy that a person had purchased in the past; a length of time the prior insurance policy was active; a list and description of insurance policies associated with an entity, including insurance policies that are currently active or inactive/expired; insurance coverage 24r for each insurance policy associated with an entity; actual cash value of an asset covered by an insurance policy; information on additional equipment coverage 24s which covers other equipment added to an insured asset, such as especial rims on a car; a minimum liability coverage amount; a description of any previous damage for an insured asset; depreciation percentages per year for an insured asset; insurance deductible information 24t; gap coverage protection information, i.e., optional coverage that applies to increase an amount of recovery in the event of a total loss of an asset subject to a loan or lease agreement, where the amount of outstanding indebtedness is greater than the actual cash value; information on payment protection, which may cover insurance premiums if a person becomes disabled; an insurance rate; a loan interest rate; information on whether the policy is a paid in full policy; optional insurance coverage, such as rental reimbursement coverage to cover the costs of renting a car, or pleasure rental coverage to cover the cost of replacing a rental car that has been stolen; insurance policy cost; insurance policy limits 24u, which includes information on the monetary limits of an insurance policy; insurance premium amount; prior loans associated with an entity; contract renewal options, such as an insurance renewal options; renewal date; return premium; a stated amount value, which is the value an asset is insured for after an appraisal of the asset has been conducted; a contract type, such as a loan type or an insurance policy type, i.e., whether an insurance policy is a home owners insurance policy, automobile insurance policy, life insurance policy or a business and commercial insurance policy, etc.; a written period amount by an insurance company, which may include new business, renewals, and policy endorsements; mechanical breakdown coverage; policy coverage limits; insurance coverage exclusions; settlements paid to an entity; aggregate limit, which indicates an amount of coverage for a period of time; living and death benefits; and endorsement benefits for other assets not covered in an original insurance policy, among other insurance information.

Insurance information may further include insurance information associated with a real estate asset, including but not limited to home insurance information; sinkhole coverage data; catastrophic ground coverage information; collapse coverage information; inspection data; conditions of an asset or an asset's parts including doors, windows, electrical system, plumbing, heating and air-conditioning, roof shape, wall construction, building structure and composition, etc.

Insurance information may further include a username 24w, email address 24x and password 24y of an entity associated with the insurance information. An entity may access the insurance information using their username 24w and password 24y. An entity may make changes to the insurance information corresponding to the entity, such as adding new information, deleting old information, modifying incorrect information, etc. The insurance information may be configured to ensure that only certain insurance information may be modified. For example, an entity may be able to change their telephone number or the name of an insurance policy beneficiary 24i, but may not be able to delete their criminal record 24e or medical information 24d. In another embodiment, the entity would not be able to make any changes and would only be able to submit a request to make changes.

Insurance information may further include a measure of exposure and vulnerability to loss associated with an entity or an asset, where death of a person, dissolution of a corporation or destruction of the asset may cause financial loss. Insurance information may also include a risk profile that analyzes a history of casualties, i.e., liabilities or loss resulting from accidents associated with an entity. A risk profile may establish trends which may be considered by an insurance company in determining whether to issue an insurance policy to an entity. For example, a risk profile may alert an insurance company that an entity has recovered insurance proceeds for two or more houses that were destroyed in fires. Risk profiles may be categorized as standard, non-standard and preferred.

A risk profile may differentiate between different types of losses. For example, a first type of losses experienced by an entity may be different from a second type of losses, such as accident losses, in that first type losses do not have to be sudden and fortuitous like second type losses, but may result from repeated exposure that results in bodily injury or property damage which is not expected or intended. A risk profile may also include civil lawsuits or criminal actions that an entity has been a party to, which may help indicate how litigious an entity is.

Insurance information repository 22 may further include a description of a type of insurance policy associated with an entity. For example, an insurance policy may be an automobile liability insurance policy that provides coverage for bodily injury and property damage caused by an automobile associated with an entity. Other types of insurance policies include an automobile collision insurance policy, a comprehensive insurance policy a general liability insurance policy and a non-standard insurance policy, among others. An automobile collision insurance policy covers physical damage to an automobile. Comprehensive insurance provides protection in case of theft or damage to an automobile. General liability insurance protects from liabilities arising from accidents in premises, resulting from operations, sold products, contractual liability, negligence, etc. Non-standard insurance may include insurance provided to a high risk person, such as a person that has been refused insurance coverage.

In another exemplary embodiment, insurance information repository 22 may also include one or more lists of users who are authorized to access the insurance information associated with an entity. Insurance information repository 22 may also include the extent to which insurance information may be accessed by users. For example, users on an authorized user list may have access to all or part of the insurance information, while users that are not on an authorized user list may be able to access limited insurance information, such as an entity's primary address or information that determines whether an entity does or does not have an active insurance policy. In an exemplary embodiment, only a registered user would be able to access any but limited information. Of note, the invention is not limited to the above examples. Other types of insurance information may be included in insurance information repository 22.

In another exemplary embodiment, insurance information may be categorized according to different security levels, such as first level insurance information, second level insurance information and third level insurance information. Users on an authorized user list may be authorized to access one or more of the first, second and third level insurance information. Third level insurance information may include more sensitive insurance information than third level insurance information. By way of example, first level insurance information may include an email address, while third level insurance information may include an income associated with an entity, such as a person's salary.

In another exemplary embodiment, insurance information may also be categorized by type or class. The different types include, but may not be limited to, insurance information associated with an asset, insurance information associated with an entity, insurance information associated with financials of an entity, insurance information associated with contact information, insurance information associated with a driving record of an entity, and insurance information associated with a medical history of an entity, among other classifications. An authorized user list may indicate which category of insurance information may be accessed by which users. By way of example, the authorized user list may indicate that insurance information classified as insurance information associated with financials may be accessible by a first group of users, while insurance information categorized as insurance information associated with contact information, like a primary residence address, may be accessible by a second group of users.

Of note, although insurance information is described herein as being stored in a “database” or a “repository,” the invention is not limited to storage in a formal database management system, e.g., SQL, Access, etc. or a formal repository. It is contemplated that any memory storage device can store the insurance information in an organized and retrievable form, such as using a flat file, a hash structure, etc. Further, insurance information is not limited to information discussed above, and may include any other information.

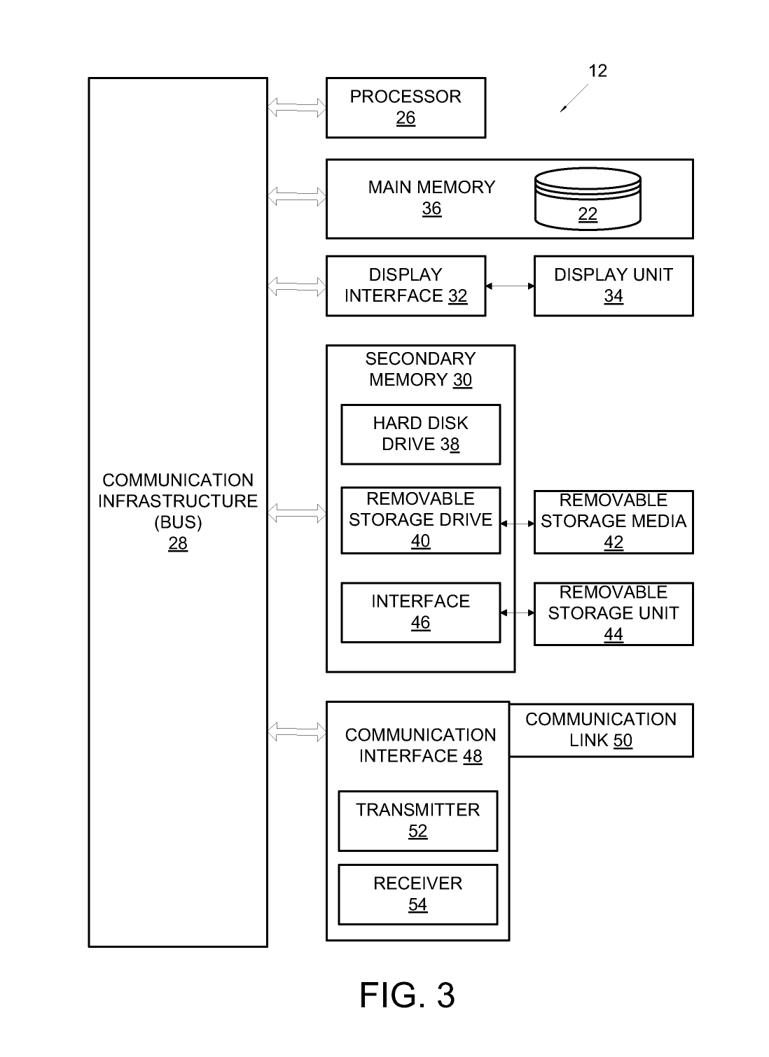

FIG. 3 is a block diagram of an exemplary insurance verification computer 12 constructed in accordance with the principles of the present invention. Insurance verification computer 12 includes one or more processors, such as processor 26 programmed to perform the functions described herein. Processor 26 is operatively coupled to a communication infrastructure 28, e.g., a communications bus, cross-bar interconnect, network, etc. Processor 26 may execute computer programs stored on disk storage for execution via secondary memory 30.

Various software embodiments are described in terms of this exemplary computer system. It is understood that computer systems and/or computer architectures other than those specifically described herein can be used to implement the invention. It is also understood that the capacities and quantities of the components of the architecture described below may vary depending on the device, the quantity of devices to be supported, as well as the intended interaction with the device. For example, configuration and management of insurance verification computer 12 may be designed to occur remotely by web browser. In such case, the inclusion of a display interface and display unit may not be required.

Insurance verification computer 12 may optionally include or share a display interface 32 that forwards graphics, text, and other data from the communication infrastructure 28 (or from a frame buffer not shown) for display on the display unit 34. Display 34 may be a cathode ray tube (CRT) display, liquid crystal display (LCD), light-emitting diode (LED) display, and touch screen display, among other types of displays. The computer system also includes a main memory 56, such as random access memory (“RAM”) and read only memory (“ROM”), and may also include secondary memory 30. Main memory 36 may store insurance information repository 22.

Secondary memory 30 may include, for example, a hard disk drive 38 and/or a removable storage drive 40, representing a removable hard disk drive, magnetic tape drive, an optical disk drive, a memory stick, etc. The removable storage drive 40 reads from and/or writes to a removable storage media 42 in a manner well known to those having ordinary skill in the art. Removable storage media 42, represents, for example, a floppy disk, external hard disk, magnetic tape, optical disk, etc. which is read by and written to by removable storage drive 40. As will be appreciated, the removable storage media 42 includes a computer usable storage medium having stored therein computer software and/or data.

In alternative embodiments, secondary memory 30 may include other similar devices for allowing computer programs or other instructions to be loaded into the computer system and for storing data. Such devices may include, for example, a removable storage unit 44 and an interface 46. Examples of such may include a program cartridge and cartridge interface (such as that found in video game devices), flash memory, a removable memory chip (such as an EPROM, EEPROM or PROM) and associated socket, and other removable storage units 44 and interfaces 46 which allow software and data to be transferred from the removable storage unit 44 to other devices.

Insurance verification computer 12 may also include a communications interface 48. Communications interface 48 allows software and data to be transferred to external devices. Examples of communications interface 48 may include a modem, a network interface (such as an Ethernet card), a communications port, a PCMCIA slot and card, wireless transceiver/antenna, etc. Software and data transferred via communications interface/module 48 may be, for example, electronic, electromagnetic, optical, or other signals capable of being received by communications interface 48. These signals are provided to communications interface 48 via the communications link (i.e., channel) 50. Channel 50 carries signals and may be implemented using wire or cable, fiber optics, a phone line, a cellular phone link, an RF link, and/or other communications channels.

It is understood that insurance verification computer 12 may have more than one set of communication interface 48 and communication link 50. For example, insurance verification computer 12 may have a communication interface 48/communication link 50 pair to establish a communication zone for wireless communication, a second communication interface 48/communication link 50 pair for low speed, e.g., WLAN, wireless communication, another communication interface 48/communication link 50 pair for communication with low speed wireless networks, and still another communication interface 48/communication link 50 pair for other communication. Communication interface 48 may include transmitter 52 and receiver 54.

Computer programs (also called computer control logic) are stored in main memory 36 and/or secondary memory 30. For example, computer programs are stored on disk storage, i.e. secondary memory 30, for execution by processor 26 via RAM, i.e. main memory 36. Computer programs may also be received via communications interface 48. Such computer programs, when executed, enable the method and system to perform the features of the present invention as discussed herein. In particular, the computer programs, when executed, enable processor 26 to perform the features of the corresponding method and system. Accordingly, such computer programs represent controllers of the corresponding device.

In an exemplary embodiment, an entity may create an account in insurance verification computer 12 in order to store and access insurance information and documents stored in insurance information repository 22 in main memory 36. Processor 26 may create an account and an account identifier. The account identifier may include an account number, a social security number, a tax identification number, or any other identification that uniquely identifies an entity. Processor 26 may further create a username 24w and password 24y that the entity may use to log into insurance verification computer 12. Username 24w may be a username selected by the entity. The account identifier, username 24w and password 24y correspond to insurance information associated with the entity. The insurance information may include insurance policy 24l.

In an exemplary embodiment, the entity may want to access the insurance information associated with their account identifier. For example, the entity may wish to access insurance policy 24l associated with the entity. Insurance policy 24l may be stored in insurance information repository 22 and may include insurance policy data. Insurance verification computer 12 may receive an insurance information access request from the entity. The insurance information access request may include the account identifier and the password. Insurance verification computer 12 may provide access to the insurance information to the entity.

In another exemplary embodiment, an entity may upload documents and enter insurance information associated with the entity into insurance verification computer 12 using a personal computer, such as a mobile telephone. The insurance information entered and the uploaded documents are associated with an account identifier corresponding to the entity. The insurance information entered is stored in insurance information repository 22. An entity may access the stored documents and insurance information by login into their account from any computer, mobile telephone, personal digital assistant, wireless mobile device, tablet computer, personal computer, etc. connected to communication network 20. Documents may be accessible from any place in the world with an Internet connection. Insurance verification computer 12 may be part of a cloud computing environment where important documents, insurance information and loan information are stored in the cloud for easy retrieval.

The insurance policy, insurance information and supporting documentation may be stored in insurance information repository 22 in insurance verification computer 12 for future retrieval. The insurance information, loan information and documents may be stored in insurance information repository 22 in memory 36 of insurance verification computer 12 for an indefinite time or for a determined amount of time. For example, insurance information repository 22 may be configured to retain the documents and insurance information for a period of five years.

In another exemplary embodiment, an insurance company may send to insurance verification computer 12 insurance information for storage in insurance information repository 22. An entity may purchase an insurance policy from an insurance company associated with a third party computer, such as insurance carrier computer 16. The third party computer, e.g., insurance carrier computer 16, may receive insurance information from the entity. The insurance information may include a name 24a of an entity, an address 24b, an entity identification 24c, and supporting documentation for the insurance policy, among other insurance information. Supporting documentation may include, for example, an official vehicle title that verifies ownership of a vehicle. The third party computer, e.g., insurance carrier computer 16, may upload the insurance information associated with the entity, including an insurance policy 24l purchased by the entity.

A third party transmitter in the third party computer, e.g., insurance carrier computer 16, may be configured to send insurance information to insurance verification computer 12. Communication interface 48 may include receiver 54 configured to receive, from the third party computer, the insurance information and a parameter, e.g. an entity identification, associated with the entity whose insurance information is being received. Processor 26 may associate the insurance information with the parameter. Memory 36 may be configured to store both the insurance information and the parameter in insurance information repository 22 for future retrieval.

For example, the third party computer may want insurance information associated with an entity. Receiver 54 in insurance verification computer 12 may be configured to receive an insurance information request message from the third party computer. The insurance information request message includes a parameter associated with an entity. Processor 26 in insurance verification computer 12 may further be configured to determine insurance information associated with the parameter at least in part by searching the insurance information repository 22 using the parameter. Processor 26 may retrieve from the insurance information repository 22 all or part of the insurance information associated with the parameter, i.e., with the entity. Transmitter 50 in insurance verification computer 12 may transmit the insurance information associated with the parameter to the third party computer.

In another exemplary embodiment, when insurance verification computer 12 receives insurance information (including a parameter associated with an entity) for storage in insurance information repository 22, processor 26 in insurance verification computer 12 may determine whether insurance verification computer 12 stores an account associated with the parameter, e.g., an entity identification, account identifier, username, etc. If processor 26 determines that there is an account already created, insurance verification computer 12 stores the insurance information and documents in the account corresponding to the received parameter.

Otherwise, if processor 26 determines that there is not an account associated with the parameter, processor 26 creates an account and an account identifier. Processor 26 proceeds to associate the account identifier with the received insurance information and the parameter. Insurance verification computer 12 stores the insurance information and documents received from the third party computer in the newly created account. Further, processor 26 may create a temporary username and password for the account. Insurance verification computer 12 may send a message including the temporary username and password to the entity associated with the new account via email. The message may contain instructions as to how to create a new username and password to login into insurance verification computer 12.

An entity may receive the email including the login instructions, and may create a new username and password to associate with their account. Alternatively, an entity may decide not to create a new username and password, and may use the temporary username and password instead to log into their account. An entity may decide not to use their account to store insurance information and documents. Even so, the account will still remain active and will be accessible by requesters, such as government computer 14, insurance carrier computer 16 and financial institution computer 18, who may search and access the insurance information associated with the account. The insurance information in insurance verification computer 12 may be made available to the entity after the entity purchases the insurance policy.

In another exemplary embodiment, regardless as to whether an entity may or may not wish to receive or access documents via insurance verification computer 12, a third party may create an account for the entity. The third party may use an entity's email address to create the entity account. Insurance verification computer 12 may send a message to the entity via, for example, email, explaining that, in order to minimize an insurance company's risk of potential economic loss or the loss of collateral in a loan application, an account for the entity has been created to store insurance information associated with the entity. The message may further explain that a third party such as the government via government computer 14, an insurance carrier via insurance carrier computer 16 and/or a financial institution via financial institution 18, may upload a document or enter insurance information associated with the entity into the entity's account for storage in insurance information repository 22.

In another exemplary embodiment, an insurance company may receive from an entity a request to purchase an insurance policy. For instance, the entity may wish to change insurance carriers. The insurance company may request from the entity a parameter associated with the entity, such as entity identification 24c, name 24a or an account identifier. Insurance carrier computer 16 may send to insurance verification computer 12 an insurance information verification request including the parameter. Insurance verification computer 12 may determine whether insurance verification computer 12 stores an account associated with the parameter and whether the account includes insurance information.

Receiver 54 in insurance verification computer 12 may receive the insurance information verification request from the third party computer, e.g., insurance carrier computer 16. The insurance information request may include the parameter associated with an entity. Processor 26 may query insurance information repository 22 using the received parameter to determine whether insurance information repository 22 includes insurance information corresponding to the parameter. Memory 36 in insurance verification computer 12 may be configured to store the insurance information repository 22 which includes the insurance information. Processor 26 may be configured to determine whether the insurance information associated with the entity includes an insurance policy. When processor 26 determines that insurance information associated with the entity and stored in insurance information repository 22 includes an insurance policy, the processor resolves that the entity has insurance. Processor 26 may determine a policy status of the insurance policy 24l. The status 24o of the insurance policy may be one of active or inactive (cancelled, lapsed, etc.).

If the entity has insurance, i.e., the processor determines that insurance information associated with the entity includes insurance policy 24l, transmitter 52 in insurance verification computer 12 may send to the third party computer, e.g., insurance carrier computer 16, a verification message verifying that insurance information associated with the entity or parameter includes an insurance policy. Transmitter 52 may also transmit the policy status 24o. Insurance verification computer 12 may further send to the requester any insurance information associated with the entity. Otherwise, if the entity does not have insurance, i.e., the processor determines that insurance information associated with the entity does not include an insurance policy, transmitter 52 in insurance verification computer 12 may send to the third party computer, e.g., insurance carrier computer 16, an alert message indicating that the entity does not have insurance. The alert message may state that no insurance information was found for the parameter provided in insurance information repository 22.

In another exemplary embodiment, insurance carrier computer 16 may send to insurance verification computer 12 an insurance policy application form corresponding to an insurance policy an entity wishes to purchase. The insurance policy application form may include blank spaces which can be filled out with insurance information. Insurance verification computer 12 may use the insurance information and supporting documentation associated with the parameter, e.g., the entity identification, to automatically fill out the blank spaces in the insurance policy application form. In another embodiment, the system would not be able to prefill blank spaces. Alternatively, insurance verification computer 12 may send insurance information associated with the parameter to insurance carrier computer 16, so insurance carrier computer 16 can use the insurance information to automatically fill out the insurance policy application form. The insurance information received by insurance carrier computer 16 from insurance verification computer 12 may be used to automatically populate an insurance policy application form.

By retrieving the insurance information from insurance verification computer 12 and using the information to fill out an insurance policy application, the chances of entering erroneous information in the insurance policy application form may decrease. Storing information in insurance information repository 22 preserves the integrity of the information used to underwrite an insurance policy, as the possibility of obtaining erroneous or false information is reduced. For example, typing errors caused by having an agent of the insurance company enter insurance information manually into insurance carrier computer 16 may be reduced or eliminated.

An insurance company may use the insurance information in insurance information repository 22 for preparing an insurance policy for a person. Insurance information, loan information and documents in insurance information repository 22 may be retrieved by a requester, such as insurance carrier computer 16, to assist in underwriting an insurance policy and/or claim processing. For example, insurance carrier computer 16 may receive insurance information stored in insurance information repository 22, such as the name 24a, address 24b, etc. of an entity from insurance verification computer 12. An agent of the insurance company may use the insurance information to fill out and write an insurance policy. Using the insurance information in the insurance information repository 22 may save the insurance company time in preparing the insurance policy, as a large percentage of the information needed by the insurance company to write the insurance policy may already be stored in insurance information repository 22.

In another exemplary embodiment, insurance verification computer 12 acts as a central repository of information obtained from different sources, including but not limited to, government computer 14, insurance carrier computer 16 and financial institution computer 18. The insurance information stored in insurance information repository 22 may be entered and retrieved by an entity who is applying for insurance, as well as a third party who wants to know insurance information associated with an entity. A third party, such as the government, an insurance company and a financial institution may enter insurance information into insurance verification computer 12 via government computer 14, insurance carrier computer 16 and financial institution computer 18 respectively. For example, an insurance company agent may enter insurance information using insurance carrier computer 16. The insurance information may include data on an entity who purchased an insurance policy from the insurance carrier. Further, any other party may store and retrieve information and documents from insurance verification computer 12 using computers (not shown) connected to communication network 20.

In another exemplary embodiment, creation of an account in insurance verification computer 12 may be free or may be associated with a cost. An entity may create an account in order to access or store insurance information in insurance information repository 22. An entity may pay for creation of the account. Alternatively, the cost may be subsidized by parties wanting to have access to the insurance information stored in insurance information repository 22. For example, the cost of maintaining accounts in insurance verification computer 12 may be subsidized by insurance companies, financial institutions and/or the government. An entity may be offered an incentive, such as a discount on an insurance premium, if the entity opens an account in insurance verification computer 12 and includes insurance information associated with the entity.

In another exemplary embodiment, an entity whose insurance information is stored in insurance information repository 22, may wish to give a third party access to the insurance information. For example, an entity wanting to purchase an insurance policy from an insurance company may allow the insurance company to access the insurance information corresponding to the entity. To that end, the entity may give an insurance company a parameter, such as an entity identification, an account identification, social security number, etc., associated with their insurance information. The insurance company may have access to this information by inputting the entity's name, address and/or driver's license number. In an exemplary embodiment, the insurance company would only receive information if the insurance verification system has any documentation for the entity. The insurance company may access the insurance information using the parameter. Insurance carrier computer 16 may download the insurance information from insurance verification computer 12.

In another exemplary embodiment, an insurance company may determine whether to issue an insurance policy to an entity based at least in part on an analysis of documents and insurance information stored in insurance information repository 22. A requester, such as a third party computer, may send to insurance verification computer 12 a request to perform an analysis of insurance information associated with an entity. The requester may send a parameter, such as an entity identification, social security, insurance policy number, username 24w, etc., associated with the entity to insurance verification computer 12. Processor 26 in insurance verification computer 12 may employ metrics to analyze the insurance information associated with the parameter. Processor 26 may also use a prediction algorithm to predict the likelihood that an entity associated with the parameter will become involved in an activity that will trigger a claim, such as an accident. Insurance verification computer 12 may send to insurance carrier computer 16 an analysis of the insurance information associated with the entity, so that the insurance company may determine whether or not to insure the entity based at least in part on the analysis.

In another exemplary embodiment, an insurance company may access insurance policies stored in insurance information repository 22 which were previously issued to an entity by the insurance company or by other insurance companies. Insurance carrier computer 16 may send to insurance verification computer 12 a parameter identifying an entity. Insurance carrier computer 16 may request that insurance verification computer 12 send to insurance carrier computer 16 insurance information including previously issued insurance policies associated with the parameter, e.g., with a person. Receiver 54 in insurance verification computer 12 may be configured to receive an insurance information request message from a third party transmitter in third party computer, the insurance information request message including the parameter associated with the entity. The insurance information request message may also include a request for insurance information corresponding to a prior insurance policy associated with the entity. Processor 26 in insurance verification computer 12 may be further configured to determine insurance information corresponding to the prior insurance policy associated with the entity. Processor 26 may also determine a length of time the prior insurance policy was active. Transmitter 52 in insurance verification computer 12 may be further configured to transmit the insurance information corresponding to the prior insurance policy associated with the entity, and the length of time the prior insurance policy was active to the third party computer. Insurance carrier computer 16 may determine whether to issue an insurance policy to the entity based at least in part on whether the entity had prior insurance coverage.

Insurance carrier computer 16 may compare the insurance information in previous insurance policies with current insurance information received from the entity to determine inconsistencies. Alternatively, insurance carrier computer 16 may request insurance verification computer 12 to compare the insurance information in previous insurance policies issued to an entity with the current insurance information supplied by the entity. The current insurance information may be transmitted by insurance carrier computer 16 to insurance verification computer 12. Insurance verification computer 12 may determine, based on the comparison, a probability that the current information supplied is fraudulent.

Insurance verification computer 12 may alert the insurance company of any discrepancies between the insurance information in the previously issued insurance policies and the current insurance information. For example, a previously issued car insurance policy may indicate that a person has been involved in three car accidents over their lifetime. However, the current insurance information that the person provided to the insurance company may instead indicate that the person has been involved in only one car accident. The discrepancy may be a typo made by an insurance company agent in entering the current insurance information into insurance carrier computer 16 for transmission to insurance verification computer 12 or may result from the person providing false information to the insurance company.

In another exemplary embodiment, financial institution computer 18 associated with a financial institution such as a lender company that offers loans, may receive insurance information from insurance verification computer 12. A financial institution may wish to confirm that an asset designated as collateral is insured so that, if a borrower defaults on a loan, the financial institution may recover the amount loaned, regardless of whether the collateral has been damaged, destroyed or stolen. Insuring an asset assigned as collateral may assure a lender that a claim can be filed with an insurance company to recover the value of the collateral in the case that the collateral is damaged, destroyed or stolen, i.e., the collateral cannot be sold. Insurance verification computer 12 may determine whether an asset is insured. Further, insurance verification computer 12 may determine whether an entity has illegally purchased double insurance coverage for an asset (“double dip”) in order to collect from two insurance companies.

Financial institution computer 18 may send to insurance verification computer 12 a parameter. The parameter may uniquely identify a person, an insurance policy, a collateral asset, etc. Insurance verification computer 12 may send to financial institution computer 18 insurance information associated with the parameter, such as insurance information on an asset designated as collateral in a contract for a loan. Insurance verification computer 12 may query insurance information repository 22 using the parameter received to determine whether an asset designated as collateral, such as a vehicle, boat, motorcycle, etc., is insured. Insurance verification computer 12 may send to financial institution computer 18 proof of insurance information associated with the parameter, e.g., an asset, such as insurance policy 24l.

In another exemplary embodiment, insurance verification computer 12 may be configured to periodically query insurance information repository 22 using a parameter associated with an asset to determine whether the asset, which was designated as collateral in a loan contract, is still insured. Processor 26 may determine whether an insurance policy is scheduled to become inactive prior to a predetermined date at least by retrieving from insurance information repository 22 a policy expiration date 24n corresponding to the insurance policy. Processor 26 may compare the policy expiration date 24n with the predetermined date.

Transmitter 52 in insurance verification computer 12 may transmit to a third party computer, e.g., financial institution computer 18, a warning message if the insurance policy is scheduled to become inactive before the predetermined date, the warning message including a policy expiration date 24n associated with an insurance policy covering the asset. Additionally, transmitter 52 may send policy status 24o to the third party computer. The policy status 24o may indicate that an insurance policy is active or inactive. Further, insurance verification computer 12 may determine that an insurance is about to expire.

Insurance verification computer 12 may send to the financial institution computer 18 a notification including the policy expiration date 24n. A real time notification may allow the financial institution to receive the insurance information faster than if the notification was mailed by the insurance company. The financial institution, upon receipt of a notification stating that a policy has expired, usually requests information from the borrower. By the time the borrower replies back to the financial institution, the collateral may have been uninsured for a period of 60 to 90 days. If during that time the borrower would have defaulted and the collateral would have been damaged, the financial institution would not have been able to recover payment for the loan.

Insurance verification computer 12 may periodically transmit changes, such as a change in insurance policy limits 24u, for an insurance policy associated with an asset to financial institution computer 18. Insurance verification computer 12 may send status updates to financial institution computer for a predetermined term, which may be the term of a loan. Insurance verification computer 12 may further transmit to financial institution computer 18 insurance information, such as a criminal record 24e, corresponding to a person who has applied for a loan at the financial institution. By way of example, receiver 54 in insurance verification computer 12 may be configured to receive from a third party computer an insurance information request message including a parameter associated with an entity or an insurance policy. The insurance information request message may include a request to alert the third party computer when a change to insurance policy 24l associated with the entity has occurred.

In another exemplary embodiment, insurance verification computer 12 may analyze insurance information to create a risk profile for an entity. Insurance information may include, for example, a number of claims filed by an entity, frequency of claims filed by an entity, or an amount of money received from an insurance company due to a claim filed, among other criteria. Insurance verification computer 12 may compare the number of claims filed by an entity against a predetermined number of claims and, if the number of claims filed by an entity is less than the predetermined number, the entity may be considered a low risk policy holder. Otherwise, if the number of claims filed by the entity is at least equal to or higher than the predetermined number, the entity may be considered a high risk policy holder. The risk profile of the entity may be constantly updated by processor 26 to reflect new insurance information entered into insurance information repository 22 by a third party computer.

Insurance verification computer 12 may also compare a zip code associated with an address of an entity to predetermined zip codes corresponding to high risk cities, such as cities where there is a high incident of stolen vehicles. If the zip code is equal to one of the predetermined zip codes, then the entity is considered a high risk policy holder. Insurance verification computer 12 may alert at least one of government computer 14, insurance carrier computer 16 and financial institution computer 18 when a risk profile of an entity indicates that the entity is a high risk policy holder. Insurance verification computer 12 may categorize a risk profile as a high risk profile, low risk profile, a standard risk profile, a non-standard risk profile or a preferred risk profile. Insurance verification computer 12 may use any other criteria that will help determine a risk profile for a person.

In another exemplary embodiment, insurance verification computer 12 may study insurance information to determine trends associated with a policy holder. For example, insurance verification computer 12 may analyze insurance information to determine a history of losses associated with an entity. Insurance verification computer 12 may send an alert to at least one of government computer 14, insurance carrier computer 16 and financial institution computer 18 when a policy holder/entity files an insurance claim requesting to be compensated for a loss.

In another exemplary embodiment, a government agency, such as the Department of Motor Vehicles (“DMV”), may access insurance information stored in insurance verification computer 12 via government computer 14. Government computer 14 may query insurance information repository 22 using a parameter that identifies or is associated with an entity or an insurance policy, to determine whether an entity is insured, i.e., whether an entity is in compliance with the financial responsibility required to obtain or retain a driver license. Alternatively, government computer 14 may send to insurance verification computer 12 a request for insurance information associated with a parameter, where the parameter may include an identification corresponding to an entity. The request for insurance information may request verification of purchase of an insurance policy. Insurance verification computer 12 may determine whether an entity has purchased automobile insurance by querying insurance information repository 22 for insurance information. Insurance verification computer 12 may query insurance information using the parameter identifying the entity.

Insurance verification computer 12 may retrieve from insurance information repository 22 insurance policy information 24l. Insurance verification computer 12 may send to government computer 14 a message indicating whether a person has purchased an insurance policy along with insurance policy 24l, which may include data on an insurance policy associated with the parameter. Insurance verification computer 12 may also send to government computer 14 form 24v. Form 24v may be form SR22, indicating that a person has insurance and therefore has complied with the requirement of financial responsibility required by the DMV.

Insurance verification computer 12 may be configured to periodically send to government computer 14 information as to whether an insurance policy associated with an entity is still active. Insurance verification computer 12 may transmit proof of insurance information to government computer 14 periodically for a predetermined amount of time. For example, proof of insurance information may be sent to government computer 14 on a monthly basis for a predetermined amount of time, such as three years.

In another exemplary embodiment, when insurance verification computer 12 determines that an insurance policy is inactive, e.g., is expired, lapsed or canceled, insurance verification computer 12 may send an alert to government computer 14, so that government computer 14 may process a suspension notice. Government computer 14 may be a computer associated with the DMV or a Tax Collector. Insurance verification computer 12 may create a report identifying entities that are associated with an insurance policy that has lapsed, i.e. the insurance is inactive. Insurance verification computer 12 may automatically compile a daily report and send it to government computer 14.

Government computer 14 may suspend the driving privileges of the entities identified by insurance verification computer 12. Government computer 14 may process suspension notices indicating the suspension of the vehicle registration for vehicles owned or driven by the entities, i.e., vehicles associated with the identified entities. Government computer 14 or insurance verification computer 12 may notify the entities that their driving privileges and their vehicle registration have been suspended by issuing a suspension of driving privileges notice. Alternatively, government computer 14 may send a request including a parameter, which may be a person's identification or an insurance policy number, to insurance verification computer 12. Government computer 14 may request insurance verification computer 12 to determine whether an insurance policy associated with the parameter has become inactive.

Currently, it may take the government about 60 to 90 days from the day the insurance policy becomes inactive to issue a notice suspension of driving privileges. Having insurance verification computer 12 automatically send an alert to government computer 14 when an insurance policy becomes inactive may expedite government processing of suspension notices. The system may notify the local government, financial institution, and entity via a free account with the insurance verification system as soon as a policy has been issued an intent to cancel. The time it takes the government to learn about the inactive insurance policy may be reduced, given that the government does not need to wait for the insurance company to prepare and mail the updates. Receiving updates on inactive insurances directly from insurance verification computer 12 is faster than receiving updates from the insurance company via postal mail. As a result, the time it takes the government to learn about an inactive insurance policy and prepare a corresponding suspension notice is reduced. The government may then mail the suspension notices to an entity whose insurance has become inactive. The time it takes an entity to receive a notice of suspension may also be reduced.

Insurance verification computer 12 notifies government computer 14 of the cancellation of the insurance policy in real time. As such, the issuances of suspension notices may increase, which gives the DMV and the Tax Collector office the ability to charge additional and higher fees more often, such as fees for reinstatement of driving privileges, renewed tags and renewed registrations. Further, having insurance verification computer 12 alert government computer 14 when insurance policies become inactive may make the government aware of the inactive insurance policy faster than if the government had to wait days (60 to 90 days) to receive the notice of cancellation in the mail.

Currently, an entity may buy an insurance policy for the sole purpose of presenting the proof of insurance to the Tax Collector Office to purchase a title, tag and vehicle registration. The title, tag and vehicle registration purchased may be valid for a long period of time, such as a two year period. Once the entity receives the title, tag and vehicle registration, the entity proceeds to cancel the insurance policy. The entity then illegally uses the title, tag and vehicle registration for the period of two years. Having insurance verification computer 12 send updates regarding inactive insurance policies on real time to the Tax Collector Office may prevent the above situation, given that the Tax Collector Office will process a suspension notice once insurance verification computer 12 sends the update on an inactive insurance policy to government computer 14.

Insurance verification computer 12 may also send an alert to each entity associated with an inactive insurance policy to inform them of the cancellation or expiration of their insurance policy. Insurance verification computer 12 may send the policy expiration date 24n via email or text message. Additionally, insurance verification computer 12 may send to each entity a warning message stating that the government has been informed of the inactive status of the insurance policy and, as a result, their driving privileges may be revoked.

In another exemplary embodiment, an entity may present proof of insurance at the Tax Collector Office in order to obtain a new or renew a title of a vehicle, tag and/or a vehicle registration. Insurance verification computer 12 may give a Tax Collector Office the ability to confirm whether the insurance presented by the entity is legitimate (at present, the Tax Collector Office does not have a system capable of confirming whether the insurance is legitimate and/or meets the state minimum requirements). Government computer 14 may send to insurance verification computer 12 a parameter to use for querying insurance information repository 22 to determine an insurance policy 24l, a policy status 24o and insurance policy limits 24u associated with the parameter. The parameter may be, for example, an insurance policy number or an identification associated with an entity. Insurance verification computer 12 may query insurance information repository 22 to determine an insurance policy 24l, a policy status 24o and insurance policy limits 24u associated with the parameter.

Insurance verification computer 12 may verify that an insurance policy number provided corresponds to a valid insurance policy for the entity applying for the title, tag or vehicle registration. Insurance verification computer 12 may also confirm whether the insurance policy meets state requirements. Insurance verification computer 12 may send to government computer 14 insurance information including an insurance policy 24l, a policy status 24o and insurance policy limit 24u. Government computer 14 may receive the insurance information and if the insurance policy is active, government computer 14 receives a verification message stating that the proof of insurance presented is legitimate, i.e., it is not a false or inactive insurance policy.

In another exemplary embodiment, insurance verification computer 12 may send to government computer 14 a message stating that an entity has reinstated an insurance policy that was cancelled or had expired. For example, the message may include insurance information such as, insurance coverage 24r and a policy effective date 24m of an insurance policy. The government and the police records may be automatically updated with the insurance information. Currently, the insurance company notifies the government and/or the police of a reinstatement of insurance by mail. As such, it may take weeks before the government and police records are updated. Having up-to-date records may prevent a police officer from erroneously arresting a driver because the out-of-date police records indicate that the driver has not reinstated their vehicle insurance policy.

In another exemplary embodiment, a law enforcement agent may send a request for insurance information, such as to verify whether an insurance policy is active, to insurance verification computer 12 using government computer 14, which may be installed in a police car. If insurance verification computer 12 determines that the insurance policy is active, insurance verification computer 12 may send to government computer 14 verification of the legitimacy of the insurance policy provided by the driver. Otherwise, if insurance verification computer 12 determines that the insurance policy is inactive or is a false insurance policy, insurance verification computer 12 may send an alert message to government computer 14. The police officer may see the message and may decide to write a ticket to the driver for driving without insurance. The number of tickets issued for driving without insurance may increase due to the law enforcement agent having the ability to verify in real time whether a driver has an active insurance policy. Increasing the number of tickets issued may increase the revenue of the police department.

Insurance verification computer 12 may further determine whether the insurance policy limits 24u comply with a state minimum insurance requirement. Government computer 14 may send to insurance verification computer 12 a request to verify whether an insurance policy associated with a parameter complies with a state minimum insurance requirement. Government computer 14 may send to insurance verification computer 12 a parameter that, for example, identifies an insurance policy or an entity. The parameter is used by insurance verification computer 12 to query insurance information repository 22 and determine whether the insurance policy limits 24u associated with the parameter comply with a state's standards. Insurance verification computer 12 may include a list of the minimum insurance requirement for each state.

Insurance verification computer 12 may query insurance information repository 22 to determine the insurance policy limits 24u associated with the parameter. Insurance verification computer 12 may compare insurance policy limits 24u with a corresponding state minimum insurance requirement. Insurance verification computer 12 may send to government computer 14 an indication that the insurance policy does or does not comply with the minimum standards set by the government. For example, if the insurance policy limits 24u are at least equal to the minimum state requirement, then insurance verification computer 12 may send to government computer 14 a message indicating that the insurance policy has an insurance policy limit that complies with the minimum state requirement. Otherwise, if the insurance policy limits 24u are less than the minimum state requirement, insurance verification computer 12 may send a warning message to government computer 14 stating that the insurance policy does not comply with the state minimum insurance requirements. Insurance verification computer 12 may also send to government computer 14 insurance policy limits 24u. The law enforcement officer may see the message on government computer 14 and may write a ticket to a driver for having insurance that does not comply with the state minimum insurance requirements.

In another exemplary embodiment, insurance verification computer 12 may send insurance information to a tax collector office so that government computer 14 may calculate taxes owed. For example, government computer 14 may send a request to insurance verification computer 12 requesting a name of a beneficiary for a life insurance policy that has been claimed. The request may include a parameter identifying a life insurance policy. Insurance verification computer 12 may send to government computer 14 a name of a beneficiary 24i of the life insurance policy.

In another exemplary embodiment, insurance verification computer 12 may determine whether a person qualifies to work for the government or qualifies to receive benefits and assistance from a government agency. For example, government computer 14 may request insurance verification computer 12 to send to government computer 14 medical information 24d associated with a person who wishes to apply for the military. Insurance verification computer 12 may receive the request for medical information including a parameter that identifies a person. Insurance verification computer 12 may query insurance information repository 22 using the parameter. Insurance verification computer 12 may determine medical information 24d associated with the parameter and may send the medical information 24d to government computer 14. Insurance verification computer 12 may analyze the medical information 24d and may alert government computer 14 when a person is not qualified to receive benefits or assistance from the government agency.

In another exemplary embodiment, insurance verification computer 12 may send a policy update to an entity when an insurance policy has been updated. For example, insurance verification computer 12 may receive from insurance carrier computer 16 a message indicating that changes have been made to the terms of an insurance policy. An insurance policy update may affect, for example, all life insurance policies. Insurance verification computer 12 may send an update message to the entities associated with the updated insurance policies. The message may notify the entities of the update and may include the new terms of the insurance policy.

In an exemplary embodiment, insurance verification computer 12 may store insurance information including an insurance policy timeline. The timeline may indicate a continuity or discontinuity in time between insurance policies. The timeline may also indicate a date when changes were made to an insurance policy. For example, the timeline may indicate that an insurance policy was updated last year to include uninsured motorist coverage. The timeline may further indicate whether an entity had prior insurance coverage. A requestor may query insurance verification computer 12 to determine whether an entity had prior insurance coverage.

In another exemplary embodiment, insurance verification computer 12 may receive an insurance information request message from a third party computer, such as insurance carrier computer 16, to return the names of people associated with a particular address. The insurance information request message may include an address and a request to determine insurance information associated with the address. Processor 26 may be configured to search insurance information repository 22 using the address. Processor 26 may determine entities whose address 24b matches that particular address. Determining that more than one entity is associated with an address may alert a third party computer that one of the entities may be committing insurance fraud.

Processor 26 may retrieve, from insurance information repository 22, insurance information associated with the address, the insurance information including at least one entity identification associated with the address. Transmitter 52 in insurance verification computer 12 may be configured to transmit to the third party computer, e.g., to insurance carrier computer 16, the insurance information associated with the address. The insurance information associated with the address may include the names of people who have used that particular address in an insurance policy application. Insurance verification computer 12 may determine a number of people associated with the particular address. If the number of people who have used the address is higher than a predetermined threshold, insurance verification computer 12 may send an alert to the third party computer, e.g., insurance carrier computer 16. For example, in an insurance application, a person may list as their primary residence address the address of a family member or a friend (instead of their own primary residence address) in order to get a lower insurance premium. This type of insurance fraud may occur in situations when the person lives in an area where the insurance rates are higher than in the area where the family member or friend lives. If many related people are associated with the address, it may be possible that the people do no really live at the address, but instead, use the address to get lower insurance premiums.

In another exemplary embodiment, financial institution computer 18 may request from insurance verification computer 12 a list of all addresses associated with a parameter, where the parameter may be associated with an entity, an asset or an insurance policy. The financial institution may start a repossession process of an asset by compiling addresses associated with an entity or the asset. An entity may be aware of the possible repossession of the asset, and may decide to store/hide the asset at a different address than the entity's address. When repossessing an asset, the financial institution may send repossession personnel to all of the addresses on the list, as the asset may be located/hidden at an address different from the address on the entity's loan application.

In another exemplary embodiment, insurance verification computer 12 may continuously monitor newly uploaded insurance policies in order to analyze the addresses associated with the new insurance policies. Insurance verification computer 12 may determine whether an address associated with a newly uploaded insurance policy is the same as an address listed in an already existing insurance policy associated with a different entity. When insurance verification computer 12 determines that a new insurance policy lists an address that is already stored in insurance information repository 22 and is associated with a different entity, insurance verification computer 12 may send a warning message to insurance carrier computer 16. The warning message may include an insurance policy number corresponding to the different entity.

In another exemplary embodiment, insurance verification computer 12 may send a text message or an email to an entity when a third party computer requests additional insurance information in order to maintain a certain benefit. For example to keep an insurance policy active, maintain driving privileges, etc. For example, an entity may receive an insurance information request message when their insurance policy may be about to become inactive (expired or cancelled). Receiver 54 may be configured to receive, from the third party computer, an insurance information request message. The insurance information request message may include a parameter associated with an entity and a request to alert the entity that additional insurance information from the entity is required in order to maintain a certain benefit, such as maintaining their driving privileges or maintaining an insurance policy active. Memory 36 may be configured to store the insurance information request message in insurance information repository 22 so that the insurance information request message can be accessed by the entity. Transmitter 52 may be configured to transmit the insurance information request message to the entity via, for example, text message or email. The text message or email message may include, for example, instructions as to how to avoid losing a benefit, such as how to avoid expiration or cancellation of the insurance policy. For example, insurance verification computer 12 may determine which insurance policies are associated with a policy expiration date 24n of next week. Insurance verification computer 12 may send an insurance information request message to entities associated with the insurance policies.

In another exemplary embodiment, insurance verification computer 12 may receive from insurance carrier computer 16, a request to send a notification to all people associated with insurance policies that are about to expire or get cancelled. Insurance verification computer 12 may receive a parameter from insurance carrier computer 16 that includes one or more insurance policy numbers that are about to become inactive. Insurance verification computer 12 may search insurance information repository 22 to determine contact information associated with the one or more insurance policy numbers. Insurance verification computer 12 may send insurance information request messages to the persons whose insurance policy is about to expire. Having insurance verification computer 12 send the insurance information request messages may allow people to be notified promptly when their insurance policy is about to become inactive. In this way, the insurance company does not have to rely on the mail service or rely on insurance agents to deliver the expiration and cancellation notifications to the affected entities. Otherwise, the notification may get lost in the mail, may never get delivered, or may not be delivered on time.

In another exemplary embodiment, a requester may query insurance information repository 22 directly. The requester may query insurance information repository 22 directly instead of requesting insurance verification computer 12 to perform the queries on behalf of the requester. A requester may retrieve insurance information from insurance information repository 22 and may save the insurance information for future use. Alternatively, a copy of insurance information repository 22 may be stored in government computer 14, insurance carrier computer 16 and/or financial institution computer 18.

In another exemplary embodiment, insurance verification computer 12 may store a list of high risk policy holders that have made fraudulent insurance claims. The list may include information associated with policy holders, i.e., entities, who have provided false or misleading information in order to obtain an insurance policy. For example, the list may include a name or an identification associated with a policy holder that has (i) filed a false injury report, (ii) filed a claim with two different insurance companies (“double dipping”), or (iii) committed any type of insurance fraud. High risk policy holders may be associated with insurance policies that have a high likelihood of being fraudulent.

A requester may request insurance verification computer 12 to determine whether an entity is classified as a high risk policy holder, i.e., whether the name or identification of the policy holder is on the list of high risk policy holders. The requester sends to insurance verification computer 12 a parameter, such as a name or identification, associated with an entity. Insurance verification computer 12 will determine whether the parameter, i.e., the name or identification, corresponds to a person on a list of high risk policy holders. If insurance verification computer 12 determines that the name or identification received corresponds to a high risk policy holder, then insurance verification computer 12 sends a warning message to the requester. Otherwise, insurance verification computer 12 sends a message stating that the policy holder is not on the list of high risk policy holders.

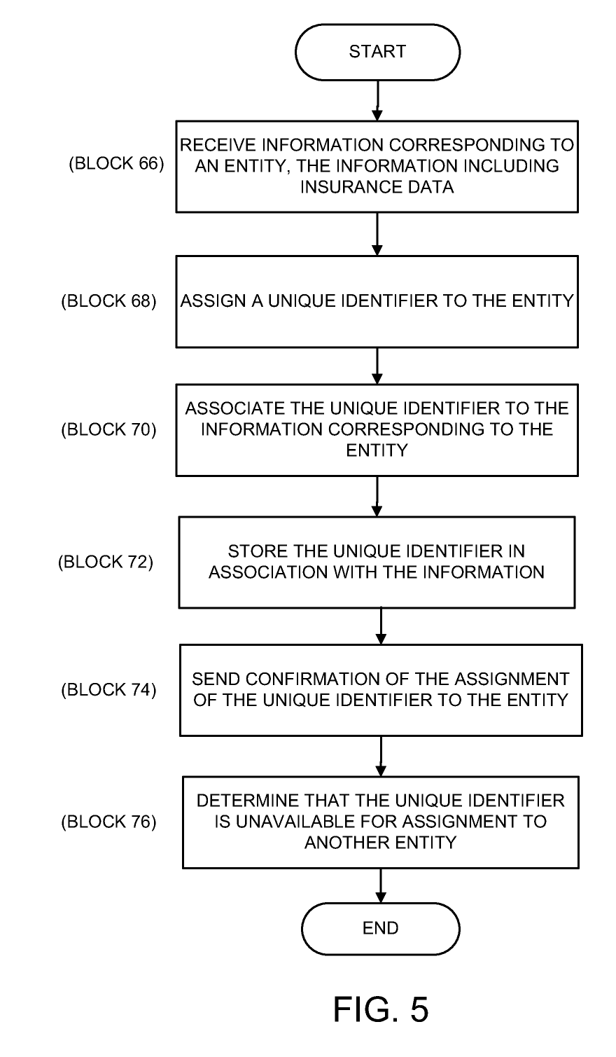

FIG. 5 is a flow chart of an exemplary process for verifying insurance information associated with an entity, where the insurance information is stored in insurance information repository 22. An insurance information verification request is received from a third party computer (Block 56). The insurance information verification request includes a parameter associated with the entity. A search of insurance information repository for insurance information associated with the entity is performed. A determination is made as to whether insurance information associated with the entity includes an insurance policy (Block 58). When it is determined that insurance information associated with the entity includes an insurance policy, a policy status of the insurance policy is determined (Block 60) and a verification message verifying that the insurance information associated with the entity includes the insurance policy is transmitted to the third party computer (Block 62). The verification message includes the insurance policy status of the insurance policy. When it is determined that the insurance information associated with the entity does not include an insurance policy, an alert message is transmitted to the third party computer (Block 64). The alert message indicates that the entity does not have insurance.

Real Time Processing—Underwriter Requests a Change

In another exemplary embodiment, data processing at insurance verification computer 12 may appear to take place, or may actually take place substantially at the same time as data entry or a command is received by insurance verification computer 12, e.g., instantaneously in real time. For example, when a named insured, i.e., an applicant/entity, fills out an insurance policy application, the entity, e.g., the applicant, decides to purchase the insurance and a policy number is issued, insurance verification computer 12 (“INSVSYS) will receive the policy just purchased. Then both the applicant/entity and the agent both sign the insurance policy application (some companies require ‘wet’ signatures and some require that the application be electronically signed) before submitting the insurance policy application to the insurance company. The insurance policy application may be sent (for example using a computer at the agent's office) via communication network 20 to an insurance company, e.g., insurance carrier computer 16, by email, fax, file transfer protocol or using any type electronic communication. Insurance verification computer 12 may receive the insurance policy application as well.

The insurance company may review the insurance policy application using insurance carrier computer 16. Insurance carrier computer 16 or insurance verification computer 12 may analyze the insurance policy application and may determine that additional documentation from the entity is needed to support the information on the insurance policy application. Additional documentation may include, but may not be limited to a copy of a vehicle registration that the entity listed in the insurance policy application and any other vehicle information related to the vehicle that the entity would like to insure. Additional information may also include a picture of the vehicle that the entity would like to insure with comprehensive and collision coverage. Additional information may further include any information the insurance company would like to request from the entity applying for the insurance policy, such as any type of information associated with an asset or person or entity that the entity would like to insure.

In another exemplary embodiment, the insurance company may require from the named insured, e.g., an entity, a request to produce certain information, such as documents and items. The insurance company may use insurance carrier computer 16 to send the request to insurance verification computer 12. The request may include a date, such as an expiration date by which the certain information must be received by the insurance company underwriter.

Once the certain information is received by the insurance company underwriter, the insurance company underwriter updates the account associated with the named insurance, e.g. entity, in insurance verification computer 12. For example, the insurance company underwriter may update the account associated with the entity to show that the insurance policy that is being applied for is in a “pending” status. A pending status may indicate that the entity has applied for an insurance policy, but the insurance policy application is pending approval from the insurance company underwriter as more documentation is needed from the entity. The insurance verification computer 12 may run a computer software program that performs the features described herein. The computer software program may be referred herein as Insurance Verification System (“INSVSYS”).

A ‘pending’ status may trigger a real time alert in insurance verification computer 12. The alert lets the entity know that the insurance company needs additional information from the entity before the insurance policy application may fall into an intent to cancel status. For example, an email including an alert message may be sent to the entity's email address. Also a text message including an alert message may be sent by insurance verification computer 12 to the entity's mobile device. Insurance verification computer 12 may send any type of alert to the entity. The alert may be sent to a device associated with the entity. The entity may read the alert using a smart phone application.

The entity can submit the additional information required by uploading documents, data, pictures, etc. into insurance verification computer 12. The entity may log into their account in insurance verification computer 12 and may determine what information is required from the entity in order for the insurance company to remove the pending status of the insurance policy application.

On the other hand, if the certain information requested by the insurance company has not been received by the insurance company or insurance company underwriter by the date set by the insurance company underwriter, the insurance company underwriter may then send to the entity a second request, which may be called “an intent to cancel.” The insurance company underwriter may send the second request to the entity's account in insurance verification computer 12 using insurance carrier computer 16. The second request may involve updating a first additional information request status to unfulfilled and indicating that a second addition information request is being initiated.

The intent to cancel request may change the status of the insurance policy that the entity is applying for to a ‘cancellation pending’ status. The change of status of the insurance policy to ‘cancellation pending,’ e.g., the receipt of an intent to cancel request at an account associated with the entity, may initiate a notification to a third party who has an interest in the entity's insurance company application such as the DMV, a lien holder, a loss payee, and/or any additional insured, if any.

For example, if the insurance company underwriter does not receive the certain information from the entity, i.e., the entity has not updated his/her account in insurance verification computer 12 with the certain information before the date set by the insurance company underwriter, then insurance verification computer 12 may send a notification in real time to a third party who has an interest in the entity's insurance policy, such as the DMV, a lien holder, a loss payee, and/or any additional insured, if any, and any other party who has interest in the insurance application policy. The insurance company underwriter may also change the status of the insurance policy application associated with the entity's account in insurance verification computer 12 to ‘final cancel’ if the second request for certain information is not fulfilled by the entity, e.g., the entity does not send or update the information requested by the insurance company. If the status of the insurance policy application is ‘final cancel’ then insurance verification computer 12 may alert any third party, such as any of the third parties mentioned above.

Running Reports

In another exemplary embodiment, insurance verification computer 12 may be configured to provide reports. For example a report may be requested by an insurance company before the insurance company issues an insurance policy to an entity. A report may include information associated with an entity. The insurance company may request a report on the entity from insurance verification computer 12, e.g., insurance verification computer may receive an information request or report request from insurance carrier computer 16.

Insurance verification computer 12 may analyze the account associated with the entity to create a report. Once insurance verification computer 12 creates the report, insurance verification computer 12 may send the information requested in the form of a report to insurance carrier computer 16. The information sent by insurance verification computer 12 may be used by the insurance company to verify and compare against the information received in the insurance policy application filled out by the entity.

Alternatively, insurance verification computer 12 may analyze the information in the insurance policy application and the information stored in an account associated with the entity to determine whether there are inconsistencies between the information in the insurance policy application and the information stored in the account associated with the entity in insurance verification computer 12.

For example, the information stored in the entity's account may include the actual/current address of the entity. This information would give the insurance company the ability to determine whether the address provided by the entity in the insurance policy application is the same address stored in the entity's account. Insurance verification computer 12 may be configured to analyze the data stored in insurance verification computer and may determine which person(s) are living at the entity's, e.g., the applicant's, address. The determined person(s) living at the entity's address may be fraudulently using the entity's address as their own in an insurance policy application.

Insurance verification computer 12 may send to insurance carrier computer 16 a list including the names of people living at the entity's address. The address verification analysis by insurance verification computer 12 may allow insurance verification computer 12 and an insurance company to determine whether there are other undisclosed drivers living at the entity's address or whether the entity has provided a fake address in the insurance policy application in order to avoid paying a higher rate corresponding to their actual address.

Insurance verification computer's 12 information verification capabilities may allow an insurance company to reduce their risk and issue insurance policies based on correct verified information. Further, insurance verification computer 12 may allow an insurance company to provide accurate re-quotes after insurance verification computer 12 analyzes the information in the report associated with the entity. Knowing this information earlier in the insurance policy application policy may allow an insurance company to lower the cost of claim processing for the insurance company. The overall costs, which may include but may not be limited to court fees, attorney fees, adjusters time in determining the status of a driver, etc., may be reduced. Insurance verification computer 12 may allow an insurance company to verify a driver's status and may reduce the number of claims paid by the insurance company, specifically when for claims that should have not been paid in the first place. For example, if a person presents a claim, and the insurance company determines, using insurance verification computer 12, that the person has provided a false address or that the person is an undisclosed driver, then the insurance company may refuse to pay the claim. Insurance verification computer 12 may increase the efficiency of an insurance company in processing claims by removing the burden of paying expenses for which the insurance company did not collect a premium for. For instance, the address verification may prevent the insurance company from paying a claim for an insurance policy including a fraudulent address, i.e., the entity has paid an insurance premium corresponding to a fraudulent address or an undisclosed driver.

In another exemplary embodiment, insurance verification computer 12 may communicate with other devices, such as a mobile device via a smart phone application, via the Internet or other networks. The information stored in insurance verification computer 12 may be also accessible via a website. An entity may submit a request to an insurance agent or an insurance company directly using, for instance, a mobile device or a website. Insurance verification computer 12 may receive an insurance policy change request associated with an insurance policy of an entity, such as a motor vehicle policy, e.g., automobile policy, a home owner's policy, a life insurance policy, etc.

Exemplary changes received by insurance verification computer 12 may include a change of a driver's name, age, a change of vehicle, a change in coverage, etc. Insurance verification computer 12 may send the change request to the insurance company, who may process the change and update the information in insurance verification computer 12 to reflect the change. Insurance verification computer 12 may update the entity's account to reflect the change in real time. The change may be instantly available on insurance verification computer 12.

In another exemplary embodiment, an entity may enter a change request in insurance verification computer 12. The change request may be stored in insurance verification computer 12 until the entity decides to submit the change. For example, when a request for change is received at insurance verification computer 12 and for any reason the entity decides not to go through with the change, the change will stay on the entity's account in insurance verification computer 12 as pending for future completion.

Driver Based Company—Truck Drivers

Insurance verification computer 12 may store a list of authorized drivers who may drive trucks belonging to a truck transportation company. Insurance verification computer 12 may receive from a truck transportation company computer a request to update a list of authorized drivers. The truck transportation company may add or remove drivers from the list of authorized drivers by submitting a request to insurance verification computer 12 in real time. Insurance verification computer 12 may transmit the change to an insurance agent of the truck transportation company and to the insurance company that insures the trucks of the truck transportation company.

Insurance verification computer 12 may receive a request from a third party, such as law enforcement or government computer 14, to verify who is an authorized driver in the list of authorized drivers. Insurance verification computer 12 may verify whether a particular driver is insured under the truck transportation company master insurance policy, i.e., the employer's master policy. Insurance verification computer 12 may send the verification to, for example, government computer 14 after determining whether a driver is an authorized driver covered under an insurance policy.

The ability of law enforcement to obtain an updated list of authorized drivers in real time from insurance verification computer 12 may encourage insured entities and an insurance company to keep an updated list of authorized drivers. Insurance verification computer 12 may send the updated list of authorized drivers upon request. This may prevent or discourage an insurance company or an entity from purposely not adding high risk drivers to the insurance policy in order to avoid paying a higher premium or from fraudulently not adding to the insurance policy a driver who has been previously denied insurance, e.g., an insurance company has declined to insure a driver.

Companies who are not in the trucking business, but nevertheless require their employees to utilize their personal vehicle for work, may create an account in insurance verification computer 12 for each employee. The companies may query insurance verification computer 12 to determine whether an employee has automobile insurance on the automobile that the employee is using for work. Insurance verification computer 12 may verify whether or not the employee has purchased automobile insurance.

Personal Insurance Companies

In an exemplary embodiment, insurance verification computer 12 may receive a request from a personal auto insurance company, e.g., insurance carrier computer 16, to verify whether an entity is included as an authorized driver in an employer's master insurance policy. Insurance verification computer 12 may verify whether an entity, who drives for a living/works as a driver, is listed as an authorized driver in the employer's master policy. Insurance verification computer 12 may send the verification to, for example, insurance carrier computer 16.

Insurance verification computer 12 may verify whether an employer, such as a transportation company, has failed to disclose a new driver to the insurance company. If an undisclosed driver who during work hours is a party to an automobile accident, insurance verification computer 12 may determine that, since the transportation company's insurance policy did not include the new driver as an authorized driver, the transportation company's insurance policy may deny the claim and the employee's personal automobile insurance policy would be responsible for the looses.

Companies Other than Truck Companies/Truck Drivers

In an exemplary embodiment, a commercial insurance company may send, using insurance carrier computer 16, a notification to insurance verification computer 12. Insurance verification computer 12 may receive the notification and may forward the notification on behalf of a third party, e.g., the commercial insurance company, to the entity. The notification may correspond to a general liability insurance policy, worker's compensation policy, commercial automobile policy, etc. For example, a notification may notify an entity of pending requirements, cancelations, renewal reminders, schedule audits, etc. The notification may be sent by insurance verification computer 12 in real time. An insurance company may issue a notice, such as a notice pending requirements, intent to cancel, audits, etc. A named insured corporate account may be notified by insurance verification computer 12.

In another exemplary embodiment, insurance verification computer 12 may store a list of all addresses associated with an entity. The list of addresses may be associated with an account corresponding to the entity. The list may include the addresses that the entity has used in the past or the address that the entity has represented as being the entity's home or mailing address. A government agency may request the list of addresses from insurance verification computer 12.

Additionally, insurance verification computer 12 may store vehicle records, including but not limited to information associated with the owner of a vehicle and a list of repairs and scheduled services corresponding to a vehicle. Other information may include data corresponding to automobile accidents in which an automobile has been involved, and the status of a title of an automobile, among other accident related data. Insurance verification computer 12 may send these data upon request.

Point of Sale (“POS”)—DVI and DVI Report

In an exemplary embodiment, insurance verification computer 12 may associate an entity with a unique identifier, such as a Driver Vehicle and Insurance Identification (“DVI”). The DVI may be issued in a card, like an identification card. The DVI may include any representation that may identify an entity, such as a number, letters, a combination of numbers and letters, a barcode, etc. A DVI may include a one dimensional (1D) code, two dimensional (2D) codes such as a MICROSOFT tag code, a Quick Response (“QR”) code, among other types of codes that may represent data. For example, the DVI may include optical machine readable codes such as a series of parallel lines or a graphical drawing.

The DVI may be a form of identification that may have an increased level of security than a driver's license. Unlike information associated with a driver's license, which can be viewed by anyone, a DVI may be viewed by the entity associated with the DVI, such as for example the driver license holder. Additionally, a DVI and information associated with the DVI stored in insurance verification computer 12 may be viewed by any other third party that the entity wishes to share the DVI with or give access to their account in insurance verification computer 12.

FIG. 5 shows an exemplary process for assigning a unique identifier. Insurance verification computer 12 may generate a DVI for an entity when an entity creates an account in insurance verification computer 12. Insurance verification computer 12 may receive information corresponding to the entity, the information may include insurance data (Block 66). Insurance verification computer 12 may assign a unique identifier of a plurality of unique identifiers available for assignment (Block 68). Once insurance verification computer 12 assigns the identifier, insurance verification computer 12 may determine that the unique identifier, e.g., the DVI, is unavailable for assignment to another entity different from the entity. Insurance verification computer may mark the unique identifier as “unavailable.” (Block 76) This may assure that a DVI is unique for each entity and no other entity may be assigned the same DVI as another entity. Insurance verification computer 12 may send a confirmation of the assignment of the unique identifier to the entity via email, text message, or any other electronic means (Block 74).

The DVI may give a sense of security to an entity, such as a named insured, given that the information associated with the DVI and stored in insurance verification computer 12 is kept secured. Insurance verification computer 12 may associate the unique identifier to the information corresponding to the entity (Block 70). Insurance verification computer 12 may store the unique identifier, e.g., DVI in association with the information corresponding to the entity for future retrieval by the entity (Block 72). The stored information may be accessible by the entity using the DVI associated with the entity.

Each account in insurance verification computer 12 may be associated with a corresponding DVI. Insurance verification computer 12 may receive, from a third party computer, an insurance information request including the unique identifier associated with the entity, wherein the third party computer is one of a government computer 14, an insurance carrier computer 16 and a financial institution computer 18. For example, insurance verification computer 12 may receive from an insurance company computer, such as insurance carrier computer 16, a message. The message may include the DVI, and may be a request for information corresponding to the entity associated with the DVI. Insurance verification computer 12 may use a particular DVI to identify the account associated with the particular DVI.

Insurance verification computer 12 may verify that the entity has given authorization to send information associated with their DVI to a third party. Insurance verification request 12 may determine whether the entity has authorized the insurance information request. If insurance verification computer 12 determines that the entity has authorized the insurance information request, then insurance verification computer 12 may retrieve the information corresponding to the entity using the unique identifier, and may send the information to the third party, e.g., the third party computer.

In another exemplary embodiment, the entity may send an insurance information request message to insurance verification computer 12. Insurance verification computer 12 may receive the insurance verification request message from the entity. The insurance verification request message may include the unique identifier associated with the entity. Insurance verification computer 12 may retrieve the information corresponding to the entity using the unique identifier, and may send the information to the entity. The information may include, for example, any information associated with the entity, such as a list of drivers authorized to drive a vehicle associated with the entity, e.g., owned by the entity. The list may be a list of drivers authorized to drive a vehicle covered by insurance purchased by the entity.

In an exemplary embodiment, an entity may register and create an account in insurance verification computer 12. Insurance verification computer 12 may request documentation or information from the entity in order to create the account. The entity may use a computer, such as a mobile device or personal computer, to send to insurance verification computer 12 the information requested in order for insurance verification computer 12 to create an account. The information may include a personalized user name, password, pin number, secret question, secret answer, etc.

Insurance verification computer 12 associates the information with the entity's account. In an embodiment, the DVI associated with an entity may not change, i.e., the DVI may be similar to a social security number, which remains the same for the lifetime of the entity. For example, a DVI may be different than a driver's license number, as a driver's license number usually changes when an entity changes their name. Using a DVI to store and retrieve information from insurance verification computer 12 may help eliminate data entry errors, such as spelling errors in names and street addresses, as instead of having to type a long name to retrieve information on an entity, a DVI may be typed. Additionally, if a person, such as an insurance agent enters a DVI in a form, insurance verification computer 12 may automatically send information to populate the name, street address, and other information associated with that DVI into a form.

Insurance verification computer 12 may assign a DVI to an entity when, for example, the entity is listed in an insurance policy. The entity may be listed as, for example, an authorized driver. A DVI may also be assigned to an entity when the entity applies for a driver's license for the first time or when an entity is listed in an insurance policy as a non-licensed driver, an excluded driver, a driver that is being renewed, etc. The DVI may also be assigned when an entity registers with insurance verification computer 12 via a website associated with insurance verification computer 12.

An entity may receive a free account in insurance verification computer 12 and a DVI number when the purchase of an insurance policy is made in person, over the phone, online, etc. and the information is received by insurance verification computer 12. In an exemplary embodiment, a DVI may be assigned to entities who have an international or foreign drivers license. Insurance verification computer 12 may be configured to communicate and receive communications from computers around the world. Insurance verification computer 12 may, for example, verify the information in the foreign driver's license by communicating with a computer in the foreign country associated with the foreign driver's license, e.g., a foreign department of motor vehicles.

In an exemplary embodiment, the entity may be associated with an international drivers license. Insurance verification computer 12 may store insurance data including international drivers license data, e.g., the international drivers license number, the country that issued the international drivers license, an English translation of the international drivers license, etc. Insurance verification computer 12 may send an international drivers license information request message to a third party computer, the third party computer may be an international government computer, e.g., a DMV of another country. Insurance verification computer 12 may receive from the international government computer, in response to the information request message sent, international drivers license information associated with the entity, such as a verification that the international drivers license associated with the entity is valid and has not expired, the address and vehicle associated with the international drivers license, a list of traffic, civil and criminal offenses associated with the international drivers license, etc.

In an exemplary embodiment, insurance verification computer 12 may receive a request of information on an insurance policy or may receive a request to purchase an insurance policy. In response, insurance verification computer 12 may send a DVI Report to a party, such as an insurance company, e.g., insurance carrier computer 16, a government computer 14, a financial institution computer 18, etc. The DVI report may be created by insurance verification computer 12 and may include a list of disclosed and undisclosed drivers associated with the insurance policy. Insurance verification computer 12 may determine the undisclosed drivers that are to be included in the DVI report by, for example, determining one or more DVIs registered with the same address.

The DVI report may additionally provide the name of other insurance policies associated with the same address, if any. The DVI report may further provide information about each driver, such as whether a driver has an out of state driver license, an international or foreign driver license, etc. Insurance verification computer 12 may determine whether an entity with an out of state driver license or international driver license is applying for an insurance policy using a local address.

In another exemplary embodiment, the DVI report may include listed and unlisted vehicles associated with the address, which may be used by insurance verification computer 12 to verify whether the insurance information provided by an applicant entity is consistent. The DVI report may include effective dates and expiration dates of an insurance policy, an status of an insurance policy, e.g., whether the insurance policy is current, cancelled, reinstated after a lapse in coverage, how long the insurance policy has been in place, the amount of insurance coverage, bodily injury limits, property damage limits, pip benefits, applicable deductibles to named insured or dependent relatives, underinsured or uninsured motorist coverage, etc.

For example, if uninsured motorist coverage has not been purchased, the DVI report by the insurance verification computer 12 may show that the entity rejected the uninsured motorist coverage. Other information included in the DVI report may include the comprehensive coverage, collision coverage and deductibles, towing and rental coverage, limits, etc. The DVI report may be analyzed by insurance verification computer 12. Insurance verification computer 12 may send to an insurance company information as to whether any of the disclosed and undisclosed drivers have been involved in prior accidents. For example insurance verification computer 12 may send disclosed and undisclosed driver information to insurance carrier computer 16.

Information in the DVI report sent by insurance verification computer 12 to, for example, insurance carrier computer 16, government computer 14 and/or financial institution 18, may include information associated with the DVI, such as the name of the parties involved in an accident where the entity associated with the DVI was involved, information about the vehicles involved in an accident, dates of the accident, how much each party received and/or recovered, a financial settlement from the insurance company, the name of a medical facility, such as clinic or hospital where each party involved in the accident received treatment, the amount of benefits an insurance company paid for each party involved in an accident, etc. This information may be sent to insurance verification computer 12 from, for example, insurance carrier computer 16, an entity using a mobile device, etc.

Information about vehicles associated with the entity corresponding to the DVI may be included in the DVI report, such as a vehicle history that includes data as to whether the vehicle for which the entity is applying for both comprehensive an collision coverage has been involved in an accident or has a vehicle title indicating that the vehicle has been rebuilt. All of the information above may be confirmed and sent by insurance verification computer 12 in response to a request to purchase an insurance policy. For example, an insurance agent may use a computer to send a request to insurance verification computer 12 for information associated with the entity applying for insurance coverage.

Other details in the DVI report may include insurance policies associated with the address on the insurance application and details on the insurance policy. For example, the DVI report may include the insurance company name, company code, mailing address, state in which the insurance policy was purchased, liability limits, property damage limits, personal injury protection limits, deductibles for the named insurance and dependent relatives, effective and expiration dates of the insurance policy, policy number, named insured information, such as driver license number, date of birth, residence address, social security number, driving history report, name and address of each driver, employment information, and insurance policy information associated with each driver, among other information. The same information may be included for each listed driver, unlisted driver, excluded driver and/or non licensed driver living at the same address. The DVI report may also include payment information such as the payment method used to purchase the insurance policy, the cost of the insurance policy, the amount and dates when payment is due, etc.

In an exemplary embodiment, insurance verification computer 12 may receive from an entity requesting to purchase an insurance policy, information classifying each disclosed and undisclosed driver included in the DVI report. Possible classifications may include authorized driver, non-licensed driver, and/or an excluded driver. A final step, before an entity may purchase an insurance policy, may include receiving by insurance verification computer 12 the email address associated with an entity's account in insurance verification computer 12 or the account number that insurance verification computer 12 assigned to the entity. This information may be provided/sent to insurance verification computer 12 by the entity.

If an entity does not have a DVI number, insurance verification computer 12 will assign a DVI number to the entity. An insurance agent may explain to the entity the advantages of registering and creating an account with insurance verification computer 12. An entity may choose not to register and/or create an account with insurance verification computer 12. Regardless as to whether an entity registers or not, insurance verification computer 12 will keep a record of the transaction, e.g., the assignment of a DVI, so that the entity may access information associated with the transaction and stored in insurance verification computer 12 using their DVI once the entity registers and creates an account in insurance verification computer 12.

Once the insurance policy has been approved by the insurance company and purchased by the entity, the policy number and details of the policy, along with the findings on the DVI report may be stored by insurance verification computer 12. For example, the insurance company may send to insurance verification computer 12 via insurance carrier computer 16, the policy number and the terms of the policy for storage and association with the account corresponding to the entity that purchased or whose name is in the insurance policy. The entity's account may be retrieved using the DVI of the entity. The DVI may be included in a message sent from the insurance carrier computer 16 to the insurance verification computer 12.

Other information, such as the name of the agent of record associated with an entity or an insurance policy application, may be sent for storage to insurance verification computer 12 from the insurance carrier computer 16. Once the insurance policy has been purchased by the entity, insurance verification computer 12 may send information associated with the insurance policy to the DMV and the corresponding tag agency on real time, such as before the entity leaves the office of the insurance agent. Insurance verification computer 12 may send the information to the tag agency, e.g., tax collector's office, verifying that the entity, who is the owner of a vehicle, is in compliance with the financial responsibilities in the state where the insurance policy was purchased, e.g., the entity has purchased insurance.

In another exemplary embodiment, if an automobile listed in an insurance policy is covered by comprehensive and/or collision coverage, insurance verification computer 12 may send to a lien holder, loss payee, and/or an additional insured listed on the insurance application confirmation of the coverage. Such notification may be automatically sent by verification computer 12.

In an exemplary embodiment, if an entity submits an application for an insurance policy for a vehicle purchased by the entity from, for example, a third party or a dealership, the insurance company may require that the entity transfers the title (i.e., the ownership) of the vehicle to their name. The insurance company may request the change of name in the title within thirty days of purchasing the insurance policy. Once an entity changes the ownership on the title of the automobile, the new owner's name may be sent by the DVM to insurance verification computer 12. For example, the DMV may use government computer 14 to send the new title to verification computer 12. The updated title or/and the update will be stored in insurance verification computer 12.

In an exemplary embodiment, an entity that registers and creates an account with insurance verification computer 12 may have access to all of their insurance policies and endorsements (any change that has been made since the insurance policy started) associated with the entity that have been requested, completed and that are in pending status. An entity may customize how the entity prefers to receive notifications from insurance verification computer 12 regarding the insurance policies and endorsements associated with the entity's account. For instance, the entity may request that insurance verification computer 12 send notifications by email, text, and/or through an smart phone application associated with insurance verification computer 12.

A named insured may request a change on their policy using their account in insurance verification computer 12. The change may be requested via a website or a smart phone application. The change may be send to the agent of record or insurance company. If sent to the agent of record, if the endorsement is not completed, insurance verification computer 12 gives the change a pending status. If sent to the insurance company and processed, then the change will be available in insurance verification computer 12.

Point of Sale for Companies Incorporating in the State

In an exemplary embodiment, once a company incorporates in the State, insurance verification computer 12 may receive information of incorporation of the company from a government computer 14. Information may include an email address, name of the company, name of the company's agent, etc. Insurance verification computer 12 may assign to the company a DVI and may create an account for the company. Insurance verification computer 12 may associate with the DVI with the company's incorporation information, email address, name of the company, name of the agent, etc. Insurance verification computer 12 may send an email to the email address on record requesting that the company completes their registration with insurance verification computer 12 by verifying the email address.

Insurance verification computer 12 may give the account a pending status until the email address is verified. In this way, once the company completes the registration with insurance verification computer 12, the company may store in insurance verification computer 12 insurance policies, such as a general liability insurance policy, a worker's compensation policy, a commercial automobile insurance policy, etc. corresponding to the company.

Claim Processing

In an exemplary embodiment, insurance verification computer 12 may be configured to produce a DVI report that may include information useful for processing and insurance claim. For example, an insurance company may request from insurance verification computer 12, via insurance carrier computer 16, a DVI report on an entity who is applying for an insurance policy. The DVI report may indicate the address of the entity and the name of other people associated with the same address, i.e., the number of people living at the same address or using the same address in an active insurance policy or driver's license. People who actually do not live at the address may fraudulently use the address in an insurance policy application in order to pay a lower insurance premium than if they used their actual address. Insurance verification computer 12 may query a government computer 14, such as a DMV computer, in order to determine who has used the same address in their driver's license. Insurance verification computer 12 may also store a database that stores DMV information and may update the DMV information by connecting periodically to a DMV computer. Any change, such as a change of name and address, may reflect instantly on insurance verification computer 12, as insurance verification computer 12 may be constantly connected to government computer 14 (there may be no need to connect periodically).

The insurance company may send via insurance verification computer 12 to the entity applying for insurance, a message requesting the entity to add the drivers (found on the DVI report as living in the same address) to the insurance policy, to exclude the drivers from the insurance company, etc. Insurance verification computer 12 may store additional insurance documents and forms. The insurance company may request insurance verification computer 12 to send the documents and forms to the entity for execution. Insurance verification computer 12 may send the documents to the entity for execution via email, etc.

The documents and forms sent by insurance verification computer 12 to the entity may include information about the other drivers who, according to the records in insurance verification computer 12, are living at the entity's address. Insurance verification computer 12 may request that the entity fill out the forms and documents. The documents and forms may include a series of options that the entity may choose from. For instance, the entity may choose to mark in the document that a driver is no longer living at the address, may choose to mark a box excluding the driver from the insurance coverage, or may choose to state that the driver is not known by the entity.

Insurance verification computer 12 may receive the filled out and executed documents and forms from the entity and may forward them to the insurance company. In this way, the insurance company may become aware of relevant information that may influence the insurance company decision to issue or not issue an insurance policy, or to modify the rates.

Ports, Entries, and Exit Points in the United States and Around the World

In an exemplary embodiment, insurance verification computer 12 may be configured to verify whether vehicles, boats, motorcycles, trailers and any other type of automobile/vehicle which have a vehicle identification number (“VIN”) have been reported as stolen. A port of entry, such as Port Everglades in Florida, may use insurance verification computer 12 to verify that a vehicle/automobile has not been reported stolen.

Insurance verification computer 12 may be configured to determine whether a VIN is associated with a stolen vehicle. Personnel at the port of entry may check the VIN of every automobile scheduled to be shipped out of the country. Personnel may entry the VIN into a government computer 14 in communication with insurance verification computer 12. Government computer 14 may send the VIN information to insurance verification computer 12 so that insurance verification computer 12 may analyze the VIN. Insurance verification computer 12 may receive the VIN and may determine the date, time and location where the VIN is being checked. Insurance verification computer 12 may use the VIN to query a stolen vehicle database. The stolen vehicle database may be stored in insurance verification computer 12. The stolen vehicle database includes the VIN of vehicles that have been reported stolen.

Insurance verification computer 12 determines, based at least in part on whether the stolen vehicle database includes the VIN, whether the automobile associated with the VIN has been reported as stolen. Insurance verification computer 12 may send an alert to a computer at a port of entry, such as government computer 14, when a determination is made that the vehicle associated with the VIN has been reported stolen, e.g., the stolen vehicle database includes the VIN number. The stolen vehicle database may be stored in insurance verification computer 12 or may be stored in, for example, a government computer 14, such as a DMV or law enforcement computer in communication with insurance verification computer 12 via communication network 20.

Insurance verification computer 12 may verify the status of the vehicles, e.g., stolen status, and may keep track of the number of times the VIN has been checked and the place, date and time at which the VIN was last checked. Further, insurance verification computer 12 may store the name of the person who checked the VIN. Insurance verification computer 12 may provide the information associated with the VIN to a third party, such as a government point of entry computer 14. If a vehicle is reported stolen after it has passed a verification at a port of exit, when a claim is opened, insurance verification computer 12 may provide the insurance company with a detailed description of the date, time, place and name of the person who was last to check the VIN.

For example, the unique identifier, e.g., the DVI, may be associated with a motor vehicle. The insurance verification computer 12 may receive from a government computer 14 associated with a port of entry, a VIN associated with the motor vehicle. Insurance verification computer 12 may determine, based at least in part on the VIN, whether the motor vehicle has been classified as stolen. If insurance verification computer 12 determines that the motor vehicle has been classified as stolen, insurance verification computer 12 sends a warning message that the motor vehicle has been classified as stolen to the government computer 14. Else, if insurance verification computer 12 determines that the motor vehicle has not been classified as stolen, insurance verification computer 12 sends a message indicating that the motor vehicle has not been classified as stolen to the government computer.

The information associated with the VIN may be stored in insurance verification computer 12 and accessible by an insurance company for processing a claim. The VIN information may include the type of vehicle associated with the VIN, the year the vehicle was manufactured, the color of the vehicle, the name of the owner of the vehicle, etc. The VIN information may aid the insurance company in determining what happened to the property that an entity made a claim for. The insurance company may determine, based at least in part on the VIN information, whether there was foul play involved, i.e., whether the vehicle associated with the insurance policy has not been stolen, but instead the owner of the vehicle has sold the vehicle to be shipped out of the country.

Insurance verification computer 12 may make it difficult for vehicles with a VIN to go undetected at a port of entry. Insurance verification computer 12 may make it hard for vehicles that are valuable enough to be shipped out of the country at the port of entry to go unnoticed for more than a few hours. Insurance verification computer 12 may be in communication with a computer at a port of entry (for example, government computer 14 may be at a port of entry). Insurance verification computer 12 may send a notification to interested parties, such as the insurance company (e.g., insurance carrier computer 16), a government agency (e.g., government computer 14), law enforcement (e.g., government computer 14), and the owner of the automobile, among other parties, when insurance verification computer 12 determines that the VIN corresponding to an automobile scheduled to be shipped at a port of entry is associated with a stolen automobile.

The notification sent by insurance verification computer 12 to the interested parties may allow the interested parties to recover the property and apprehend the person(s) responsible for the theft and fraud. This may minimize the insurance company loss and the loss of owner of the vehicle, as by being notified, they may send a message via insurance verification computer 12 to the personnel at the port of entry. The message may alert personnel at the point of entry and may request that they stop the shipping of the vehicle out of the country. Insurance verification computer 12 may also alert law enforcement personnel, e.g., by sending a notification to government computer 14.

For example, the motor vehicle may be associated with an insurance policy issued by the insurance company. If insurance verification computer 12 determines that the motor vehicle has been classified as stolen, then insurance verification computer 12 may transmit a warning message to the insurance company, e.g., insurance carrier computer 16, a law enforcement agency, etc. The warning message may include the location of the port of entry where the motor vehicle is scheduled to be shipped from, where the motor vehicle is located, where an inquired has been made regarding for shipping the motor vehicle out of the country, etc.

In an exemplary embodiment, insurance verification computer 12 receives a Vin associated with a first motor vehicle and determines, based on the VIN, whether the VIN is associated with a second motor vehicle, e.g., whether the VIN is a duplicate VIN. Insurance verification computer 12 may also determine if the VIN corresponds to a salvage/total loss vehicle, or if the VIN is invalid (has a letter that is not used in VINs). If it is determined that the VIN is associated with the second motor vehicle, or if it is determined that the VIN is invalid, or if it is determined that the VIN corresponds to a salvage vehicle or totaled vehicle, then insurance verification computer 12 transmits an alert message, the alert message may include the second motor vehicle information.

Highway Tolls (Ex. SunPass)

In an exemplary embodiment, an entity may purchase a prepaid toll device configured to be used to pay tolls via, for example, radio frequency or radio waves. The prepaid toll device may pay the toll when the automobile drives by a toll booth. The prepaid toll device may be associated with an automobile, such as a car, a recreational vehicle (“RV”), a motorcycle, etc. The prepaid device may be installed in the windshield of the automobile. Insurance verification computer 12 may associate the account of the entity owning the prepaid toll device with the prepaid toll device (the account stored in insurance verification computer 12).

In an exemplary embodiment, insurance verification computer 12 may determine that the automobile associated with the prepaid toll device has been reported stolen. For example, insurance verification computer 12 may communicate with a computer associated with a law enforcement agency, e.g., government computer 14, and may download from the computer associated with the law enforcement agency stolen automobile data, such as a list of automobiles that have been reported stolen and the corresponding prepaid toll device associated with the stolen automobiles.

Insurance verification computer 12 may also communicate with a computer at a toll booth. In an alternate embodiment, insurance verification computer 12 may communicate with another government computer 14 which is in communication with the computer at the toll booth. Insurance verification computer 12 may receive information from the computer at a toll booth or the other government computer 14 regarding which prepaid devices have been used to pay for a toll at the toll booth. Insurance verification computer 12 may compare the list of automobiles that have been reported stolen.

Insurance verification computer 12 may analyze the stolen automobile data and may determine that the stolen automobile associated with the prepaid toll device has passed through a toll booth, e.g., that the prepaid toll device was used to pay for the toll. Authorities may track the vehicle movement stored in insurance verification computer 12 on a police car or on a mobile device application.

For example, insurance verification computer 12 will update the account associated with the prepaid toll device to indicate that the automobile associated with the prepaid toll device has been reported stolen. Insurance verification computer 12 may notify interested third parties, such as the owner of the vehicle, the insurance company and law enforcement of the location of the toll booth where the vehicle deemed stolen has passed through. Insurance verification computer 12 may send a message to a 911 operator with the location of the toll booth where the stolen vehicle passed through. The notification may give interested parties a greater chance of recuperating the stolen vehicle, and may minimize the owner and the insurance company loss.

Insurance verification computer 12 may send, in real time, to one or more interested third party computers, such as an insurance company and law enforcement computers, a picture taken by the toll booth, the date and time that the vehicle passed through the toll booth. Insurance verification computer 12 may also upload the photograph and the date and time to a website or may make the information available to a police car computer via a communication network 20. Government computer 14 may be a computer operating in a police car. Additionally, insurance verification computer 12 may be configured to allow a smart phone application to access information, such as the photograph and the date and time when the stolen vehicle crossed the toll booth.

Smart Phone Application

In an exemplary embodiment, insurance verification computer 12 may be in communication with a smart phone application downloaded to a mobile device. The smart phone application associated with insurance verification computer 12 may be a free application available for download on, for example, the Internet or an application marketplace. An entity may download the smart phone application via a communication network 20. The smart phone application may allow the entity to send and receive information from insurance verification computer 12 using a mobile device. Insurance verification computer 12 may send data to a mobile device and may receive data from the mobile device using an interface, such as the smart phone application.

In an exemplary embodiment, insurance verification computer 12 may receive a request for a change in information, e.g., such as a request to update information associated with an entity's account. Insurance verification computer 12 may also receive an insurance claim from the entity and a claim update request. It may be convenient for the entity to be able to report a claim and keep track of their claim process using their mobile device.

In another exemplary embodiment, insurance verification computer 12 may be configured to route information received via the smart phone application to a third party, such as a claim adjuster. Insurance verification computer 12 may receive data from a mobile device and may determine an intended recipient for the data. Insurance verification computer 12 may transmit the data to the intended recipient. For instance, an entity may use the smart phone application to communicate and interact with the claim adjuster handling their insurance claim. Insurance verification computer 12 may receive an interact request from the mobile device, e.g., a request to interact and communicate with the claim adjuster. Insurance verification computer 12 may establish a connection with a computer associated with the intended recipient and may send the interact request to the computer associated with the intended recipient.

In another exemplary embodiment, the smart phone application may allow an entity to tag a picture, create a document, tag a document, provide a short description of an automobile accident, provide information regarding: the parties involved in an automobile accident (including a DVI number associated with each party), the extent of the injuries experienced by the party, the automobiles involved in an accident, and any other information associated with an insurance policy. Insurance verification computer 12 may communicate with the smart phone application stored in a mobile device to receive and/or send information, such as the information described herein.

Insurance verification computer 12 may receive a picture and a request to associate the picture with information, e.g., tag a picture. The information to be associated with the picture may be received by insurance verification computer 12 or may be, for example, already stored in insurance verification computer 12. Insurance verification computer 12 may transmit to the mobile device information that may be associated with the picture, so that an entity may choose which information to associate with the picture. The information to be associated with the picture may be available from a third party computer. Insurance verification computer 12 may communicate with the third party computer to receive the information to be associated with the picture.

Insurance verification computer 12 may save the document created using the smart phone application and may tag the document, similarly to how a picture is tagged. Insurance verification computer 12 may receive from a mobile device information regarding: the parties involved (including a DVI number associated with each party), the extent of the injuries experienced by the party, the automobiles involved, for example, the automobiles involved in an accident, and any other information associated with an insurance policy, and may store the information. The smart phone application may improve the efficiency of the claim process, as the smart phone application gives the entity the ability to enter and receive information associated with a claim at all times.

Odometer Records

In another exemplary embodiment, insurance verification computer 12 may receive data from an automobile odometer, such as the number of miles or kilometers an odometer or odograph indicates an automobile has travelled. The data may be transmitted via communication network 20. The odometer data may also be sent via communication network 20 to insurance verification computer 12 or entered directly into insurance verification computer 12. An entity may send a request to store odometer data to insurance verification computer 12.

Insurance verification computer 12 may receive a request to store the distance, e.g., actual miles, travelled by an automobile. Insurance verification computer 12 may send the distance to third parties, such as insurance carrier computer 16.

The resale value of a vehicle is often strongly influenced by the number of miles or kilometers a passenger vehicle has on the odometer, yet odometers are inherently insecure because they are under the control of their owners. Odometer records may assist the insurance companies to receive from insurance verification computer 12, the actual miles of the vehicles the insurance company insures with comprehensive and collision coverage. For instance, most vehicles have digital clusters, even if the vehicle is out of battery, the odometer would not show the miles on the vehicle, specially if the vehicle is stolen or if it is considered a total loss. In these cases, the insurance company would not know the actual miles on the vehicle.

A service department may have a computer in communication with insurance verification computer 12. A service department may include a new car dealership, a used car dealership, a mechanic shop, or any other automobile repair or maintenance center that offers vehicle services. The service departments may enter into their computers the customer's DVI and send it to insurance verification computer 12. Insurance verification computer 12 may send, in response, a list of vehicles associated with the DVI. The list of vehicles may include vehicles owned by an entity associated with the DVI.

Once the service has been completed, then insurance verification computer 12 may store the service performed on the vehicle, the miles on the vehicle, the date and time service was performed, and the location where the service was performed. The odometer records are of interest for everyone involved in the purchase or sale of a vehicle. By updating the mileage records at a service station and sending the updated mileage to insurance verification computer 12, the alteration of odometers data may be prevented and insurance companies may be able to determine the value of vehicles using actual unaltered odometer data.

Department of Motor Vehicles

In an exemplary embodiment, an entity, such as an individual, may be getting their driver's license for the first time, or may be getting an in-state driver license after having an out-of-state driver's license, international license, or foreign driver's license. The entity/individual may apply for a driver license at the Department of Motor Vehicles. The DMV may enter the individual information on insurance verification computer 12. The DMV may assist the entity to register using insurance verification computer 12 before the DMV issues a driver's license for the entity. The DMV may send the entity's information to insurance verification computer 12.

If the entity already has a registration with insurance verification computer 12, then the status of the entity may be changed to their new status, such as a new address, a different state driver's license, etc. In one embodiment, the entity's DVI number may remain the same, and may never change or be reused. If an individual is applying for an identification card (“ID”), then the individual will be assigned a DVI by insurance verification computer 12. Insurance verification computer 12 may search a database for DVI numbers registered with the same address provided by the entity. Insurance verification computer 12 may send a message to the insurance company, for example to insurance carrier computer 16, notifying the insurance company of the non-licensed driver in the household. Whenever the non-licensed driver applies and receives a driver's license, a learner's license or an operator's license, the driver will still be associated with the same DVI number, and insurance verification computer 12 may notify the insurance company of the change from non-licensed to licensed driver.

In another exemplary embodiment, an individual may change their name or address with the DMV. The DMV may update insurance verification computer 12 with the new information by associating the DVI of the entity with the new information. The change may be documented for the individual's records, and insurance verification computer 12 may send the individual reminders that the insurance company needs to be notified of the address or name change. The insurance company may request to be notified by insurance verification computer 12 whenever an individual changes their name or address. The notification may come directly or indirectly from the DMV through insurance verification computer 12.

When a request to change a name or address is received by insurance verification computer 12, then insurance verification computer 12 may search for the DVI associated with the address and may notify the insurance company of the new driver in that address. If an individual moves from one state to another state and applies for a license in their new state, their DVI, reports, insurance policies, claims history, etc. associated with their DVI will be available as before the move (as if they never left). However, the new address and the state they have moved to will be updated in insurance verification computer 12, in addition to their new state driver's license.

Additional locations that require active insurance, such as the tax collector's office (tag agency), safety inspection stations, smog and emission control inspections and other governmental offices, may verify that an entity has insurance by requesting insurance information associated with a DVI from insurance verification computer 12.

Total Loss

When a vehicle has been declared a total loss by an insurance company, the insurance company takes ownership of the vehicle and may sale the vehicle at an auction. Once the vehicle is sold at an auction, the new owner of the vehicle registers the vehicle and the registration data is sent to insurance verification computer 12. The DMV may require an inspection of the vehicle whenever the owner is requesting a rebuild title for the vehicle, to ensure that the vehicle is in driving condition.

When the vehicle passes the inspection, the DMV may issue to the owner a certificate which may be used to obtain a re-build title, along with a sticker that may be glued to the driver's door that states the vehicle is a re-build vehicle. Once the DMV processes the certificate of inspection, the DMV may update insurance verification computer 12 to include the processing of the certificate of inspection. Insurance verification computer 12 may store all data associated with the vehicle being rebuild in a database. Insurance companies may query insurance verification computer 12 for this information when comprehensive and collision coverage is purchased for the vehicle having the rebuild title.

Even if the sticker is removed from the vehicle, the type of title associated with the vehicle may be obtained from insurance verification computer 12. When a vehicle has a rebuild title, insurance verification computer 12 may notify an insurance company that a vehicle has been classified as a rebuild, specially when the insurance company is considering issuing a policy with comprehensive and collision coverage.

Law Enforcement

In an exemplary embodiment, state law may require that every household member with a valid driver's license be listed on an insurance policy associated with any member of the household. Insurance verification computer 12 may provide the list of household members of a particular household (where the household members have a valid driver's license) to law enforcement. For example, insurance verification computer 12 may send to government computer 14, which may be associated with law enforcement, a list of household members that have a valid driver's license. Insurance verification computer 12 may also send to government computer 14 a list of unauthorized drivers associated with a household.

A law enforcement official may stop a vehicle and may determine that the person driving the vehicle is not included on any list of authorized or unauthorized drivers. The law enforcement official may use government computer 14 to enter information that identifies the vehicle or an insurance policy associated with the vehicle. Insurance verification computer 12 may send a message to government computer 14 that the person driving the vehicle cannot be found in any list of authorized or unauthorized drivers. Additionally, insurance verification computer 12 may determine that the person driving the vehicle is not a member of the household and that the driver is an authorized driver, as the driver would not fall under the law requirement for household members (if not in any list, the insurance company allows permissive use, but if a driver is on an unauthorized list, that is problematic).

In another exemplary embodiment, insurance verification computer 12 may store the DVI and insurance policy associated with an entity. If an excluded driver or an unauthorized driver is involved in a car accident, an insurance policy may not cover the damages, given that the driver has been excluded or has been denominated an unauthorized driver. Insurance companies have problems dealing with uninsured, unlisted and unauthorized drivers, but the problems may be resolved using the methods explained under the Point of Sale section.

In another exemplary embodiment, an entity, such as an owner of a vehicle, may have various auto insurance policies in a household, but there may only be certain driver's authorized to drive certain vehicles. The authorized drivers may be unauthorized drivers of other vehicles insured under a different insurance policy, which avoids paying a higher premium.

For example, if a law enforcement official stops a vehicle, the law enforcement official may use the DVI of the driver to determine the status of an insurance policy associated with the DVI. The law enforcement official may use government computer 14 to send the DVI and/or the tag number of the automobile to insurance verification computer 12. Insurance verification computer 12 may determine an insurance policy associated with the DVI or the tag number.

Insurance verification computer 12 may transmit to government computer 14 a list of vehicles the driver associated with the DVI is authorized to drive. Additionally, insurance verification computer 12 may send to government computer 14 a message indicating the existence or non-existence of an insurance policy associated with the driver or the automobile. For example, a message may include an indicator or instructions for government computer 14 to flash an indicator. The indicator provided may be a green indicator, which indicates that the driver and/or automobile is associated with an active insurance policy, a yellow indicator which indicates that the insurance policy is pending cancellation, an orange indicator which indicates the insurance policy is scheduled to be cancelled in five days, and a red indicator indicating that there is not an active insurance policy associated with the vehicle or the driver.

If the law enforcement official enters into insurance verification computer 12 the DVI of the driver or tag number of the vehicle, insurance verification computer 12 may provide one of the four indicators (green, yellow, orange and red) to indicate whether or not there is an insurance policy associated with the driver or automobile, and if there is an insurance policy associated with the driver or automobile, the status of the insurance policy (active, pending cancellation or cancelled). Of note, although color indicators are mentioned, the invention is not limited to such. Any type of indicator may be used to implement the invention. For example, numbers, graphical or sound indicators may be used, among others.

A law enforcement agent may also query insurance verification computer 12 to determine whether any passenger is in an authorized list of drivers for that particular vehicle or is an unauthorized or excluded driver of that particular vehicle. If neither the passenger nor the driver is an authorized driver, then the law enforcement agent may require that the vehicle stop operating. However, if the driver is included as an authorized driver or if the driver is not on any list, then the law enforcement agent may allow the vehicle to continue operating.

In an exemplary embodiment, insurance verification computer 12 stores insurance policy records associated with drivers that are not excluded or un-authorized. For example, a person may lend his/her vehicle to a family member or a friend who does not live with the person, e.g., the vehicle owner. If the family member or friend is stopped by the police while driving the vehicle, the police will store in insurance verification computer 12 all records associated with the traffic stop, including any ticket issued to the family member or friend.

Duplicate Vehicle Identification Number (“VIN”)—Discrepancies on the VIN, Stolen Vehicles—Rebuilt Titles—Salvage Titles

In an exemplary embodiment, insurance verification computer 12 stores the VIN number and other information associated with a vehicle. Storing VINs in insurance verification computer 12 may prevent the duplication of VINs, e.g., where two cars are associated with the same VIN, one of the cars must have been fraudulently associated with the VIN. Insurance verification computer 12 may prevent having a vehicle use a VIN corresponding to another vehicle.

When a vehicle is manufactured, the vehicle may associated with a unique VIN, which is not used for any other vehicle. A manufacturer may store in insurance verification computer 12 VINs corresponding to the vehicles manufactured at a location. Each VIN may be stored in association with other information, such as the make, model, color and year. Additionally, when the vehicles are shipped from the manufacturer to a dealership, the dealership name and location may be stored in association with the VIN.

A consumer may visit the dealership to purchase a vehicle. The dealership may use a computer to send to insurance verification computer 12 the name of the customer, e.g., the new owner, and any other information associated with the new owner, such as the name of the financial institution that is handling the loan for the vehicle, the name of the insurance company insuring the vehicle, etc., for storage in insurance verification computer 12.

Duplicate Vehicle Identification Numbers

Nowadays, vehicles are not stolen for parts anymore. Vehicles are stolen mostly for resale. The vehicles are given a duplicate VIN, e.g., a duplicate VIN corresponding to a different vehicle is created and placed on top of the original VIN. Without even removing a single screw from the vehicle, the vehicle is then sold.

In an exemplary embodiment, when the duplicate VIN number is sent to insurance verification computer 12 by any entity (such as the DMV when the new owner wants to register the stolen vehicle or the insurance company when the owner of the stolen vehicle want to purchase insurance on the vehicle), insurance verification computer 12 may alert the authorities. Insurance verification computer 12 may determine that the VIN number corresponds to a vehicle that has been reported stolen. The request to register the vehicle or purchase insurance may be received in person, online, or over the phone.

Insurance verification computer 12 may alert the previous insurance company that insured the vehicle before it was stolen and the new insurance company that is considering insuring the vehicle or that is currently insuring the vehicle. Insurance verification computer 12 may present different options to the insurance companies on how they would like to proceed. For example, insurance verification computer 12 may send to an entity, such as an insurance company, all information related to the vehicle, including an alert message advising the insurance company of the duplicate VIN number.

Insurance verification computer 12 may receive a request to purchase insurance for the vehicle, the request may include the duplicate VIN. Insurance verification computer 12 may send an error message in response to the request to obtain insurance. For example, insurance verification computer 12 may not allow the purchase of the insurance policy until the original insurance company that insured the vehicle before it was stolen could confirm that the original owner of the vehicle was located and the car is in the possession of the original owner again.

In another exemplary embodiment, insurance verification computer 12 may allow the purchase of insurance for the vehicle and may allow the vehicle to be registered. However, insurance verification computer 12 may alert the authorities with the place where the VIN was insured and registered for a second time, for instance the tax collectors office location. Insurance verification computer 12 may alert the authorities whenever data corresponding to a stolen vehicle is received, such as when the vehicle has been insured and registered. For example, if a VIN is entered into insurance verification computer 12, and it contains letters or numbers which are not used in VINs, e.g., I, O, Q, or has consecutive zeros (0000).

In another exemplary embodiment, insurance verification computer 12 may determine that a stolen vehicle may be insured and registered in a state other than the state the vehicle was stolen from. Insurance verification computer 12 may alert the insurance company that insured the vehicle or that owned the vehicle when it was stolen. The alert may include the location of the vehicle. The new insurance company insuring the vehicle may also be alerted. Insurance verification computer 12 may receive a VIN and may determine that the VIN corresponds to a vehicle that is insured, registered and has been classified as a stolen vehicle in the state it was stolen from, i.e., the VIN may have a status discrepancy. Insurance verification computer 12 may send the location of the vehicle to the insurance company. In this way, the insurance companies with interest in the vehicle may be able to locate the vehicle before an accident occurs.

In another exemplary embodiment, insurance verification computer 12 may receive the VIN of the vehicle from a computer at a tax collectors office, a safety inspection station, a smog and emissions inspection station, and any other government office. Insurance verification computer 12 may receive a request to issue a tag, title and registration for the vehicle. Insurance verification computer 12 may allow the issuance of the tag, title and registration for the stolen vehicle, but may alert the authorities and the insurance company of the location of the stolen vehicle.

In another exemplary embodiment, a car manufacturer in Japan may ship a vehicle to the United States. A duplicate VIN may be used on a vehicle stolen in a different state or sold and shipped to another country. A stolen vehicle may be given by a thief a VIN corresponding to a vehicle that is similar to the stolen vehicle, where the vehicle is considered a total loss or has a salvage title. Thieves may do this to prevent people from finding out the real VIN of the stolen vehicle. Insurance companies may query insurance verification computer 12 to determine whether an automobile has been stolen in a different state, helping the insurance company recover losses that it may otherwise would not.

In an exemplary embodiment, a free application may be offered. The free application may communicate with insurance verification computer 12. The free application may allow an entity to communicate with insurance verification computer 12 to retrieve information on a claim associated with the entity. For example, the application may allow the entity to keep track of a claim, interact with a claim adjuster, tag pictures and documents, provide a short description of the accident, view information on the parties involved and the extent of their injuries, view information about the vehicles involved with their D&I number, policy number, and/or email address. The adjuster may also use the free application to determine the extents of an entity's liability, which may improve the efficiency of the claim process.

In an exemplary embodiment, a vehicle may be declared a total loss or salvage. Insurance verification computer 12 may automatically classify the vehicle status given by the insurance company. Insurance verification computer 12 may update the status of a VIN to a total loss or salvage title upon receiving information from the insurance company of the status of the vehicle. This may prevent the VIN to be associated with a stolen vehicle. An entity, e.g., a consumer, may be protected by allowing the consumer to check the VIN of an automobile using insurance verification system 12. Insurance verification computer 12 may allow an entity to check a VIN. The entity may log into their account in insurance verification computer 12. Alternatively, the entity may contact their insurance company. The insurance company may check the status of the VIN using insurance verification system 12, and may advise the consumer as to whether the status shows that the motor vehicle corresponding to the VIN is classified as stolen, that the VIN is a duplicate VIN, that the automobile associated with the VIN is a salvage or total loss, etc.

In another exemplary embodiment, a motor vehicle dealer may protect themselves from financial loss by checking the VIN of motor vehicles using insurance verification computer 12. Similarly, a financial institution may determine the status of the VIN corresponding to a motor vehicle in insurance verification computer 12 before issuing a loan on the motor vehicle (any vehicle, motorcycle, motor home, etc.). When an entity applies for insurance (collision and comprehensive) using insurance verification system 12, for a motor vehicle that has a total loss or salvage title, then insurance verification computer 12 may alert the insurance company.

Keep Records of Dates, Times, Requesters and Results

Insurance verification computer 12 may be deployed around the world, and may include data on vehicles, motorcycles, boats, motor homes, etc. Insurance verification computer 12 may keep records on those vehicles. No vehicle, motorcycle, boat, motor homes, etc would go undetected. The vehicles may be registered and their records available worldwide. Since a vehicle identification number does not change, insurance verification computer 12 may keep records of the vehicle identification number or identifier, e.g., VIN, for a long time, starting from the manufacturing of the vehicle, to the sale of the vehicle. Insurance verification computer 12 may keep track and store data on all owners of a vehicle, detailed accidents reports, detailed repair reports, pictures, etc.

In an exemplary embodiment, when an insurance company receives a claim, insurance verification computer 12 may send a list of authorized and unauthorized drivers. Vehicles may be verified by insurance verification computer 12 with the DVI reports run at the point of sale. The present invention can be realized in hardware, software, or a combination of hardware and software. Any kind of computing system, or other apparatus adapted for carrying out the methods described herein, is suited to perform the functions described herein. A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for uniquely identifying an entity, the method comprising:
receiving information corresponding to the entity, the information corresponding to the entity including insurance data;
assigning a unique identifier of a plurality of unique identifiers to the entity;
associating the unique identifier to the information corresponding to the entity;
storing the unique identifier in association with the information corresponding to the entity for future retrieval by the entity;
sending a confirmation of the assignment of the unique identifier to the entity; and
determining that the unique identifier is unavailable for assignment to another entity different from the entity.

2. The method of claim 1, the method further comprising:
receiving, from a third party computer, an insurance information request including the unique identifier associated with the entity, wherein the third party computer is one of a government computer, an insurance carrier computer and a financial institution computer;
determining whether the entity has authorized the insurance information request;
if it is determined that the entity has authorized the insurance information request, then:
retrieving the information corresponding to the entity using the unique identifier; and
sending the information to the third party computer.

3. The method of claim 1, further comprising:
receiving an insurance information request message from the entity, the insurance information request message including the unique identifier associated with the entity;
retrieving the information corresponding to the entity using the unique identifier; and
sending the information to the entity, the information including a list of drivers authorized to drive a vehicle associated with the entity.

4. The method of claim 1, wherein the entity is associated with an international drivers license, the insurance data including international drivers license data, the method further comprising:
sending an international drivers license information request message to a third party computer, the third party computer being an international government computer; and
receiving, from the international government computer, international drivers license information associated with the entity.

5. The method of claim 1, wherein the unique identifier is assigned to the entity upon receiving an application request for one of a driver's license and an identification card.

6. The method of claim 1, wherein the unique identifier is associated with a motor vehicle, the method further comprising:
receiving, from a government computer associated with a port of entry, a Vehicle Identification Number (“VIN”) associated with the motor vehicle; and
determining, based at least on the VIN, whether the motor vehicle has been classified as stolen; and
if it is determined that the motor vehicle has been classified as stolen, then sending a warning message that the motor vehicle has been classified as stolen to the government computer;
else, if it is determined that the motor vehicle has not been classified as stolen, sending a message indicating that the motor vehicle has not been classified as stolen to the government computer.

7. The method of claim 6, wherein the motor vehicle is associated with an insurance policy issued by an insurance company, the method further comprising:
if it is determined that the motor vehicle has been classified as stolen, then:
transmitting a warning message to the insurance company, the warning message including the location of the port of entry.

8. The method of claim 7, further comprising:
if it is determined that the motor vehicle has been classified as stolen, then:
transmitting a warning message to a law enforcement agency, the warning message including the location of the port of entry where the motor vehicle is scheduled to be shipped from.

9. The method of claim 1, further comprising:
receiving a Vehicle Identification Number (“VIN”) associated with a first motor vehicle;
determine, based at least in part on the VIN, whether the VIN is associated with a second motor vehicle; and
if it is determined that the VIN is associated with the second motor vehicle, transmitting an alert message including second motor vehicle information.

10. An insurance verification computer for uniquely identifying an entity, the insurance verification computer comprising:
a transmitter;
a memory in communication with the transmitter;
a receiver, the receiver in communication with the transmitter and the memory, the receiver is configured to receive information corresponding to the entity, the information corresponding to the entity including insurance data;
a processor, the processor in communication with the receiver, the transmitter and the memory, the processor configured to:
assign a unique identifier of a plurality of unique identifiers to the entity; and
associate the unique identifier to the information corresponding to the entity; and
the memory is configured to store the unique identifier in association with the information corresponding to the entity for future retrieval by the entity;
the transmitter is configured to transmit a confirmation of the assignment of the unique identifier to the entity; and
the processor is further configured to determine that the unique identifier is unavailable for assignment to another entity different from the entity.

11. The insurance verification computer of claim 10, wherein the receiver is further configured to receive, from the third party computer, an insurance information request including the unique identifier associated with the entity, wherein the third party computer is one of a government computer, an insurance carrier computer and a financial institution computer;
the processor further configured to determine whether the entity has authorized the insurance information request;
if the processor determines that the entity has authorized the insurance information request, then:
the processor retrieves the information corresponding to the entity using the unique identifier; and
the transmitter sends the information to the third party computer.

12. The insurance verification computer of claim 10, wherein the receiver is further configured to:
receive an insurance information request message from the entity, the insurance information request message including the unique identifier associated with the entity;
the processor is further configured to retrieve the information corresponding to the entity using the unique identifier; and
the transmitter is further configured to send the information to the entity, the information including a list of drivers authorized to drive a vehicle associated with the entity.

13. The insurance verification computer of claim 10, wherein the entity is associated with an international drivers license, the insurance data including international drivers license data, and wherein the transmitter is further configured to send an international drivers license information request message to a third party computer, the third party computer being an international government computer; and the receiver is further configured to receive, from the international government computer, international drivers license information associated with the entity.

14. The insurance verification computer of claim 10, wherein the unique identifier is assigned to the entity upon receiving an application request for one of a driver's license and an identification card.

15. The insurance verification computer of claim 10, wherein the unique identifier is associated with a motor vehicle, and wherein:
the receiver is further configured to receive from a government computer associated with a port of entry, a Vehicle Identification Number (“VIN”) associated with the motor vehicle; and
the processor is further configured to determine, based at least on the VIN, whether the motor vehicle has been classified as stolen; and
if the processor determines that the motor vehicle has been classified as stolen, then the transmitter is further configured to send a warning message that the motor vehicle has been classified as stolen to the government computer;
else, if the processor determines that the motor vehicle has not been classified as stolen, then the transmitter is further configured to send a message indicating that the motor vehicle has not been classified as stolen to the government computer.

16. The insurance verification computer of claim 15, wherein the motor vehicle is associated with an insurance policy issued by an insurance company, and wherein:
if the processor determines that the motor vehicle has been classified as stolen, then:
the transmitter is further configured to transmit a warning message to the insurance company, the warning message including the location of the port of entry.

17. The insurance verification computer of claim 16, wherein if the processor determines that the motor vehicle has been classified as stolen, then:
the transmitter is further configured to transmit a warning message to a law enforcement agency, the warning message including the location of the port of entry where the motor vehicle is scheduled to be shipped from.

18. The insurance verification computer of claim 10, wherein:
the receiver is further configured to receive a Vehicle Identification Number (“VIN”) associated with a first motor vehicle;
the processor is further configured to determine, based at least in part on the VIN, whether the VIN is associated with a second motor vehicle; and
if the processor determines that the VIN is associated with the second motor vehicle, the transmitter is further configured to transmit an alert message including second motor vehicle information.

19. A system for uniquely identifying an entity, the system comprising:
an insurance verification computer comprising:
a transmitter;
a memory in communication with the transmitter;
a receiver, the receiver in communication with the transmitter and the memory, the receiver is configured to receive information corresponding to the entity, the information corresponding to the entity including insurance data;
a processor, the processor in communication with the receiver, the transmitter and the memory, the processor configured to:
assign a unique identifier of a plurality of unique identifiers to the entity; and
associate the unique identifier to the information corresponding to the entity; and
the memory is configured to store the unique identifier in association with the information corresponding to the entity for future retrieval by the entity;
the transmitter is configured to transmit a confirmation of the assignment of the unique identifier to the entity; and
the processor is further configured to determine that the unique identifier is unavailable for assignment to another entity different from the entity; and
a government computer at a port of entry, the government computer being in communication with the insurance verification computer, the government computer comprising a government transmitter configured to transmit to the insurance verification computer a Vehicle Identification Number (“VIN”) associated with a motor vehicle and the unique identifier;
wherein the processor is further configured to determine, based at least on the VIN, whether the motor vehicle has been classified as stolen; and
if the processor determines that the motor vehicle has been classified as stolen, then the transmitter is further configured to send a warning message that the motor vehicle has been classified as stolen to the government computer.

20. The system of claim 19, wherein the government computer further includes a government receiver, the government receiver configured to receive the warning message.
